(19) United States
(12) Patent Application Publication
(10) Pub. No.: US 2024/0210846 A1
(43) Pub. Date: Jun. 27, 2024

(54) IMAGE FORMATION APPARATUS

(71) Applicant: Oki Electric Industry Co., Ltd., Tokyo (JP)

(72) Inventor: Karin HASEGAWA, Tokyo (JP)

(73) Assignee: Oki Electric Industry Co., Ltd., Tokyo (JP)

(21) Appl. No.: 18/528,208

(22) Filed: Dec. 4, 2023

(30) Foreign Application Priority Data
Dec. 19, 2022 (JP) 2022-202305

(51) Int. Cl. G03G 9/08; G03G 15/00; G03G 15/08

(52) U.S. Cl. CPC G03G 9/0819; G03G 15/0856; G03G 15/0877; G03G 15/5087; G03G 2215/0106

(57) ABSTRACT

An image formation apparatus according to an embodiment may include: a first image formation unit including a storage part storing a glitter developer and configured to form a glitter developer image with the glitter developer; and a controller configured to control an operation of the first image formation unit based on print data received. The controller is configured to: when a remaining amount of the glitter developer in the storage part is a first remaining amount, to form the glitter developer image such that the glitter developer image is divided per unit area by a first division number; and when the remaining amount of the glitter developer in the storage part is a second remaining amount less than the first remaining amount, to form the glitter developer image such that the glitter developer image is divided per unit area by a second division number smaller than the first division number.

### CROSS REFERENCE TO RELATED APPLICATIONS

This application claims priority based on 35 USC 119 from prior Japanese Patent Application No. 2022-202305 filed on Dec. 19, 2022, entitled “IMAGE FORMATION APPARATUS”, the entire contents of which are incorporated herein by reference.

### BACKGROUND

The disclosure may relate to an image formation apparatus, such as an image formation apparatus that is suitably applied to an electrophotographic printer.

In a related art, an image formation apparatus (may also be referred to as a printer) is widely used, which performs printing, by forming a developer image (a toner image) using a developer (or a toner) with an image formation unit based on image data supplied from a computer, an external device or the like, transferring the developer image to a medium such as paper, and then applying heat and pressure to the developer image to fix the developer image to the medium.

Among developers, for example, in order to provide a glittering properties, there is a developer such as a silver developer that contains a glitter pigment such as aluminum. There is an image formation apparatus that specifies, in order to obtain a metallic luster, the weight average molecular weight of a silver developer, the size of a glitter pigment and the content of the glitter pigment in the silver developer so as to form a printed product having a high glittering property (FI value) (see, for example, Patent Document 1).

Patent Document 1: Japanese Patent Application Publication No. 2019-113783

### SUMMARY

However, in the image formation apparatus as described above, when a printed product including a glitter developer is printed, it may be difficult to obtain a stable metallic luster.

An object of an embodiment of the disclosure may be to provide an image formation apparatus that can stabilize the metallic luster of a printed product.

An first aspect of one or more embodiments of the disclosure may be an image formation apparatus that may include: a first image formation unit that includes a storage part that accommodates therein a glitter developer and is configured to form a glitter developer image with the glitter developer; and a controller configured to control an operation of the first image formation unit based on print data received, wherein the controller is configured to: when forming a glitter image on a medium based on a predetermined print data in a state where a remaining amount of the glitter developer in the storage part is a first remaining amount, to form the glitter developer image such that the glitter developer image is divided per unit area by a first division number; and when forming the glitter image on the medium based on the predetermined the print data in a state where the remaining amount of the glitter developer in the storage part is a second remaining amount less than the first remaining amount, to form the glitter developer image such that the glitter developer image is divided per unit area by a second division number smaller than the first division number.

A second aspect of one or more embodiments of the disclosure may be an image formation apparatus that may include: a first image formation unit that includes a storage part that accommodates therein a glitter developer and is configured to form a glitter developer image with the glitter developer; and a controller configured to control an operation of the first image formation unit based on print data received, wherein the controller is configured to: when forming the glitter image on the medium based on a predetermined print data in a state where a remaining amount of the glitter developer in the storage part is a first remaining amount, to form a glitter developer image that is divided by a first division number such that the glitter developer image is formed with a first area ratio per unit area; and when forming the glitter image on the medium based on the predetermined print data in a state where the remaining amount of the glitter developer in the storage part is a second remaining amount less than the first remaining amount, to form a glitter developer image that is divided by the first division number such that the glitter developer image is formed with a second area ratio smaller than the first area ratio per unit area.

According to at least one of the aspects described above, it is possible to obtain a printed product that can suppress an increase in metallic luster from the start of use of the glitter developer in the first image formation unit until the completion of use of the glitter developer even when the remaining amount of glitter developer is decreased and has a stable metallic luster.

Accordingly, it is possible to realize an image formation apparatus capable of stabilizing a metallic luster of a printed product.

### BRIEF DESCRIPTION OF DRAWINGS

FIG. 1 is a left side view illustrating a configuration of an image formation apparatus;

FIG. 2 is a left side view illustrating a configuration of an image formation unit;

FIG. 3 is a block diagram illustrating a control configuration of the image formation apparatus;

FIG. 4 is a diagram illustrating a print pattern;

FIG. 5 is an enlarged view illustrating a print pattern PT1;

FIG. 6 is an enlarged view illustrating a print pattern PT2;

FIG. 7 is an enlarged view illustrating a print pattern PT3;

FIG. 8 is an enlarged view illustrating a print pattern PT4;

FIG. 9 is a table indicating print patterns corresponding to a dot count in Examples and Comparative Examples;

FIGS. 10A, 10B, and 10C illustrate changes in the print pattern based on the dot count, wherein an upper portion of FIG. 10A illustrates a plan view of the print pattern PT2 and a lower portion of FIG. 10A illustrates a cross sectional view taken along the line A-A in the upper portion of FIG. 10A, an upper portion of FIG. 10B illustrates a plan view of the print pattern PT3 and a lower portion of FIG. 10B illustrates a cross sectional view taken along the line A-A in the upper portion of FIG. 10B, and an upper portion of FIG. 10C illustrates a plan view of the print pattern PT3 and a lower portion of FIG. 10C illustrates a cross sectional view taken along the line A-A in the upper portion of FIG. 10C;

FIG. 11 is a diagram illustrating the emission of light and the reception of light performed by a variable angle photometer;

FIG. 12 is a table indicating results of evaluation of a luster and a color gamut;

FIG. 13 is an enlarged cross sectional view of the lower portion of FIG. 10A;

FIG. 14 is an enlarged cross sectional view of the lower portion of FIG. 10C;

FIGS. 15A and 15B are diagrams illustrating states of the silver developer and the cyan developer before and after the fixation according to the particle size of the silver developer, wherein FIG. 15A illustrates the state of the silver developer when the particle size of the silver developer is small and FIG. 15B illustrates the particle size of the silver developer is large;

FIG. 16 is a table illustrating a FI value and a C* value with respect to a silver developer image area occupancy ratio;

FIG. 17 is a block diagram illustrating a functional configuration of the image formation apparatus;

FIGS. 18A, 18B, and 18C illustrate changes in a print pattern based on a dot count according to another embodiment (1), wherein an upper portion of FIG. 18A illustrates a plan view of the print pattern PT102 and a lower portion of FIG. 18A illustrates a cross sectional view taken along the line A-A in the upper portion of FIG. 18A, an upper portion of FIG. 18B illustrates a plan view of the print pattern PT103 and a lower portion of FIG. 18B illustrates a cross sectional view taken along the line A-A in the upper portion of FIG. 18B, and an upper portion of FIG. 18C illustrates a plan view of the print pattern PT103 and a lower portion of FIG. 18C illustrates a cross sectional view taken along the line A-A in the upper portion of FIG. 18C;

FIGS. 19A, 19B, and 19C illustrate changes in a print pattern based on a dot count according to another embodiment (2), wherein an upper portion of FIG. 19A illustrates a plan view of the print pattern PT102 and a lower portion of FIG. 19A illustrates a cross sectional view taken along the line A-A in the upper portion of FIG. 19A, an upper portion of FIG. 19B illustrates a plan view of the print pattern PT103 and a lower portion of FIG. 19B illustrates a cross sectional view taken along the line A-A in the upper portion of FIG. 19B, and an upper portion of FIG. 19C illustrates a plan view of the print pattern PT103 and a lower portion of FIG. 19C illustrates a cross sectional view taken along the line A-A in the upper portion of FIG. 19C;

FIGS. 20A, 20B, and 20C illustrate changes in a print pattern based on a dot count according to another embodiment (3), wherein an upper portion of FIG. 20A illustrates a plan view of the print pattern PT102 and a lower portion of FIG. 20A illustrates a cross sectional view taken along the line A-A in the upper portion of FIG. 20A, an upper portion of FIG. 20B illustrates a plan view of the print pattern PT103 and a lower portion of FIG. 20B illustrates a cross sectional view taken along the line A-A in the upper portion of FIG. 20B, and an upper portion of FIG. 20C illustrates a plan view of the print pattern PT103 and a lower portion of FIG. 20C illustrates a cross sectional view taken along the line A-A in the upper portion of FIG. 20C; and

FIGS. 21A, 21B, and 21C illustrate changes in a print pattern based on a dot count according to another embodiment (4), wherein an upper portion of FIG. 21A illustrates a plan view of the print pattern PT102 and a lower portion of FIG. 21A illustrates a cross sectional view taken along the line A-A in the upper portion of FIG. 21A, an upper portion of FIG. 21B illustrates a plan view of the print pattern PT103 and a lower portion of FIG. 21B illustrates a cross sectional view taken along the line A-A in the upper portion of FIG. 21B, and an upper portion of FIG. 21C illustrates a plan view of the print pattern PT103 and a lower portion of FIG. 21C illustrates a cross sectional view taken along the line A-A in the upper portion of FIG. 21C.

### DETAILED DESCRIPTION

Descriptions are provided hereinbelow for one or more embodiments based on the drawings. In the respective drawings referenced herein, the same constituents are designated by the same reference numerals and duplicate explanation concerning the same constituents is omitted. All of the drawings are provided to illustrate the respective examples only.

### 1. Configuration of Image Formation Apparatus

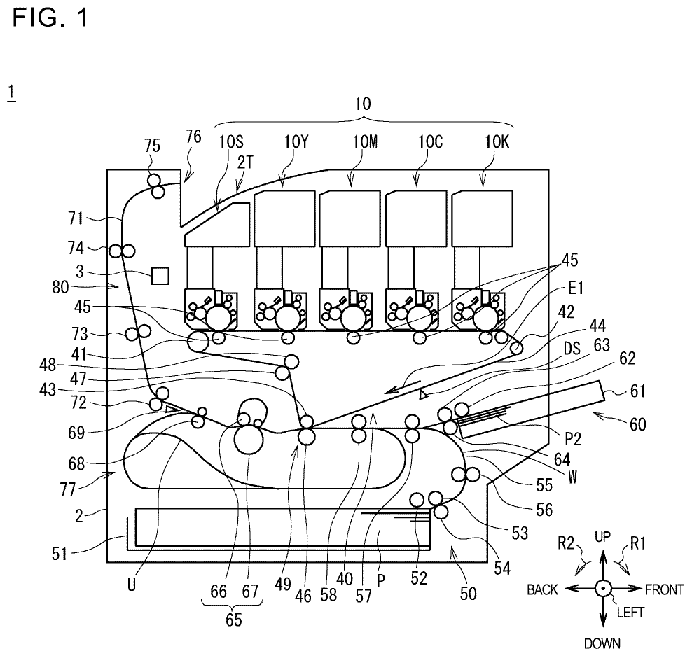

As illustrated in FIG. 1, an image formation apparatus 1 according to an embodiment is an electrophotographic printer, which is capable of forming (i.e., printing) a color image on paper P as a medium. Note that the image formation apparatus 1 illustrated in FIG. 1 is a single function printer (SFP) having a printer function, without having an image scanner function to read a document, a communication function using a telephone line, or the like.

The image formation apparatus 1 includes various parts arranged inside a housing 2 (an apparatus housing) substantially formed in a box shape. In the following description, the rightmost portion in FIG. 1 is the front of the image formation apparatus 1, and the vertical, horizontal, and front-rear directions are defined as seen facing the front.

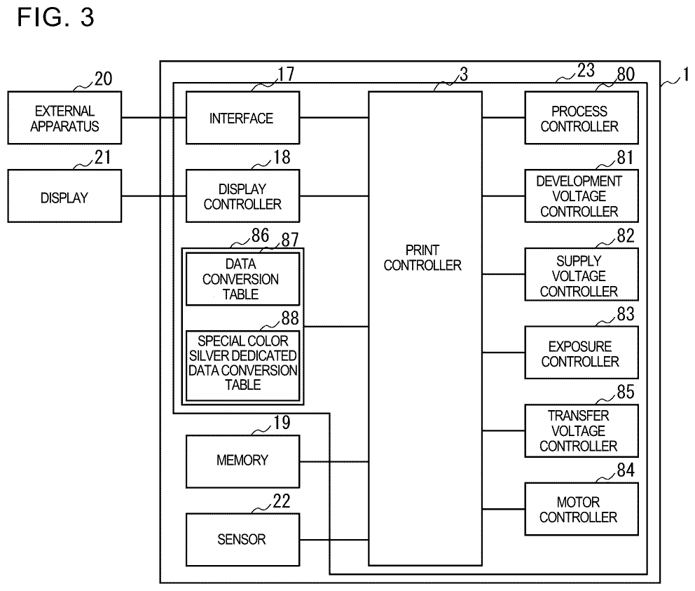

The image formation apparatus 1 is entirely controlled by a print controller 3. The print controller 3 includes a CPU (Central Processing Unit) 23 (FIG. 3), ROM (Read Only Memory), RAM (Random Access Memory) and the like and executes various processes by reading and executing predetermined programs. The print controller 3 is connected wirelessly or by wire to an external apparatus (or a host apparatus) 20 (see FIG. 3) such as a computer device. When image data representing an image to be printed and an instruction to print based on the image date are received from the external apparatus 20, the print controller 3 performs a printing process of forming a print image on a surface of the paper P.

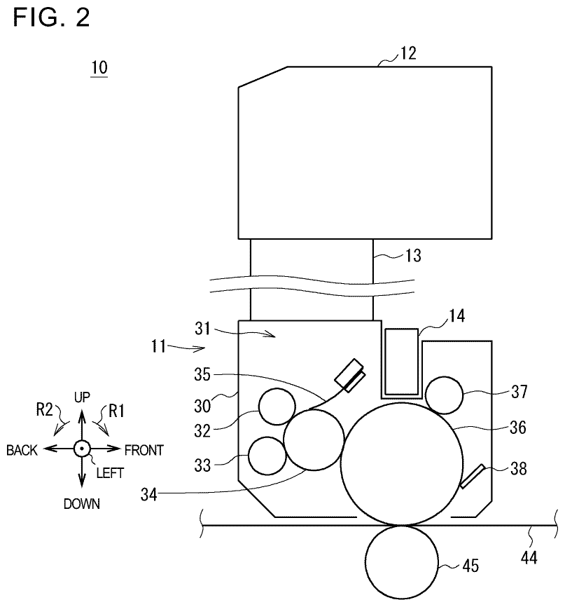

At an upper portion in the housing 2, five image formation units 10K, 10C, 10M, 10Y and 10S are arranged in order from the front side to the rear side. The image formation units 10K, 10C, 10M, 10Y, and 10S respectively correspond to a black color (K), a cyan color (C), a magenta color (M), a yellow color (Y), and a special color (S), but are different only in color and have the configuration same as each other. In the upper side inside the housing 2, an LED (Light Emitting Diode) head 14 (FIG. 2) is provided opposite the image formation units 10K, 10C, 10M, 10Y and 10S.

Black (K), cyan (C), magenta (M) and yellow (Y) are all colors used in general color printers (hereinafter referred to as normal colors). On the other hand, the special color (S) is a special color, such as white, clear (transparent or colorless), silver, or the like. For convenience of explanation, the image formation units 10K, 10C, 10M, 10Y, and 10S are hereinafter also referred to as the image formation unit 10.

As illustrated in FIG. 2, the image formation unit 10 is roughly divided into an image formation main body 11, a developer container 12 and a developer supply unit 13. Incidentally, the image formation unit 10 and each component thereof has a sufficient length in the left-right direction in accordance with the length in the left-right direction of the paper P. For this reason, many of the components have a relatively long length in the left-right direction compared to the lengths in the front-back direction and in the up-down direction, and thus are formed in an elongated shape along the left-right direction.

The developer container 12 accommodates therein a developer and is configured to be detachably attached to the image formation unit 10. Upon being mounted on the image formation unit 10, the developer container 12 is attached to the image formation unit main body 11 via the developer supply unit 13. The developer container 12 may also be referred to as a toner cartridge.

Incidentally, as a developer of silver, a developer containing a glitter pigment is used. For ease of description, in the following description, the developer of silver is also referred to as a silver developer. As the developers of yellow, magenta, cyan and black, developers containing organic pigments such as pigment yellow, pigment blue, pigment red and carbon black are used. For ease of description, in the following description, the developers of yellow, magenta, cyan and black are also collectively referred to as color developers. Furthermore, in the following description, the color developers of yellow, magenta, cyan and black are also referred to as a yellow developer, a magenta developer, a cyan developer and a black developer.

The image formation unit main body 11 (FIG. 2) are formed with an image formation casing 30, a developer storage space 31 (a developer storage room 31), a first supply roller 32, a second supply roller 33, a development roller 34, a development blade 35, a photosensitive drum 36, a charging roller 37, and a cleaning blade 38. Among these, each of the first supply roller 32, the second supply roller 33, the development roller 34, the photosensitive drum 36, and the charging roller 37 is configured in a cylindrical shape with a central axis along the left-right direction, and is rotatably supported by the image formation casing 30.

Incidentally, in the image formation unit 10S of the special color (S), the developer container 12 in which the developer of a color (such as clear color, gold or silver) previously selected by a user is stored is fitted to the image formation main body 11 via the developer supply unit 13.

The developer storage space 31 accommodates therein the developer to be supplied from the developer container 12 via the developer supply unit 13. Each of the first supply roller 32 and the second supply roller 33 includes an elastic layer made of conductive urethane rubber foam or the like formed on the circumferential surface thereof. The development roller 34 includes, at the circumferential surface thereof, an elastic layer, a surface layer having conductivity, and the like. The development blade 35 is made of, for example, a stainless steel plate of a predetermined thickness. A part of the development blade 35 is in contact with the circumferential surface of the development roller 34, in a state where the development blade 35 slightly elastically deformed.

The photosensitive drum 36 includes a thin charge generation layer and a thin charge transport layer sequentially formed on the circumferential surface thereof, and thus is able to be charged. The charging roller 37 includes a conductive elastic member coating the circumferential surface thereof. The circumferential surface of the charging roller 37 is in contact with the circumferential surface of the photosensitive drum 36. The cleaning blade 38 is made of, for example, a thin sheet of resin. A part of the cleaning blade is in contact with the circumferential surface of the photosensitive drum 36 in a state where the cleaning blade 38 is slightly elastically deformed.

The LED head 14 is located above the photosensitive drum 36 of the image formation unit main body 11. The LED head 14 includes a plurality of light-emitting element chips arranged in a straight line along the left-right direction. The LED head 14 emits lights from light-emitting elements in a light-emitting pattern based on an image data signal supplied from the print controller 3 (FIG. 1).

The image formation unit main body 11 rotates the second supply roller 33, the development roller 34, and the charging roller 37 in the direction of the arrow R1 (clockwise in FIG, 2) and rotates the first supply roller 32 and the photosensitive drum 36 in the direction of the arrow R2 (counterclockwise in FIG. 2), with a driving force(s) being supplied from a motor(s) (not illustrated). Furthermore, the image formation main body 11 applies, based on the control of print controller 3, a predetermined bias voltage to each of the first supply roller 32, the second supply roller 33, the development roller 34, the development blade 35 and the charging roller 37, and thus they are charged.

The first supply roller 32 and the second supply roller 33 thus have the developer in the developer storage space 31 adhered to the charged circumferential surfaces thereof, and the rotations of the first supply roller 32 and the second supply roller 33 have the adhered developer adhered to the circumferential surface of the development roller 34. The development blade 35 removes excess developer from the circumferential surface of the development roller 34 so as to form a thin layer of the developer on the circumferential surface of the development roller 34, and the rotation of the development roller 34 forwards the thin layer of the developer to bring in contact with the circumferential surface of the photosensitive drum 36.

On the other hand, the charging roller 37 with being charged contacts the photosensitive drum 36, so as to uniformly charge the circumferential surface of the photosensitive drum 36. The LED head 14 sequentially emits lights at predetermined time intervals to expose the photosensitive drum 36 in a light emission pattern based on the image data signal supplied from the print controller 3 (FIG. 1). As a result, an electrostatic latent image is formed on the circumferential surface of the photosensitive drum 36 in the vicinity of the upper end of the photosensitive drum 36.

Then, the rotation of the photosensitive drum 36 in the direction of the arrow R2 brings the portion where the electrostatic latent image is formed into contact with the development roller 34. Thus, the developer is adhered to the electrostatic latent image on the circumferential surface of the photosensitive drum 36, to develop a developer image based on the image data. The rotation of the photosensitive drum 36 further in the direction of the arrow R2 moves the developer image to reach the vicinity of the lower end of the photosensitive drum 36.

An intermediate transfer section 40 is located below the image formation units 10 in the housing 2 (FIG. 1). The intermediate transfer section 40 is provided with a drive roller 41, a driven roller 42, a backup roller 43, an intermediate transfer belt 44, five primary transfer rollers 45, a secondary transfer roller 46, and a reverse bending roller 47. Of these, the drive roller 41, the driven roller 42, the backup roller 43, each of the primary transfer rollers 45, the secondary transfer roller 46, and the reverse bending roller 47 are all formed in a cylindrical shape with a central axis extending along the left-right direction, and are rotatably supported by the housing 2.

The drive roller 41 is disposed on the rear lower side of the image formation unit 10S, and is rotated in the direction of the arrow R1 when drive power is supplied from a belt motor (not illustrated). The driven roller 42 is located on the front lower side of the image formation unit 10K. The upper ends of the drive roller 41 and the driven roller 42 are located at the same height as or slightly lower than the lower ends of the photosensitive drums 36 (FIG. 2) of the image formation units 10. The backup roller 43 is located on the front lower side of the drive roller 41 and on the rear lower side of the driven roller 42.

The intermediate transfer belt 44 is an endless belt composed of a high resistance plastic film and is wound and suspended around the drive roller 41, the driven roller 42, and the backup roller 43. In the intermediate transfer section 40, the five primary transfer rollers 45 are provided below an upper line of the intermediate transfer belt 44 stretched between the drive roller 41 and the driven roller 42, i.e., directly below the five image formation units 10 respectively, in such a manner that the five primary transfer rollers 45 are respectively opposed to the five photosensitive drums 36 of the image formation units 10 across the upper line of the intermediate transfer belt 44. The predetermined bias voltage is applied to the primary transfer rollers 45 serving as a transfer part based on the control of the print controller 3.

The secondary transfer roller 46 serving as the transfer part is positioned directly below the backup roller 43, and is biased toward the backup roller 43. That is, the intermediate transfer section 40 sandwiches the intermediate transfer belt 44 between the secondary transfer roller 46 and the backup roller 43. A predetermined bias voltage is also applied to the secondary transfer roller 46. The secondary transfer roller 46 and the backup roller 43 may be collectively referred to as a secondary transfer part 49.

The reverse bending roller 47 is located at a location near the lower front side of the drive roller 41 and the upper rear side of the backup roller 43, and biases the intermediate transfer belt 44 in the upper front direction. As a result, the intermediate transfer belt 44 is in a state in which tension acts between the rollers without any slack. Also, a reverse bending backup roller 48 is provided on the front upper side of the reverse bending roller 47 and opposed to the reverse bending roller 47 across the intermediate transfer belt 44.

The intermediate transfer section 40 rotates the drive roller 41 in the direction of the arrow R1 by the drive power supplied from the belt motor (not illustrated), which causes the intermediate transfer belt 44 to run in the direction along the arrow E1. Each primary transfer roller 45 also rotates in the direction of the arrow R1 with the predetermined bias voltage being applied. This enables the image formation units 10 to transfer the developer images that have been reached to the lower ends on the circumferential surfaces of the photosensitive drums 36 (FIG. 2) to the intermediate transfer belt 44, to sequentially overlap the developer images of the respective colors on the intermediate transfer belt 44. With this, the developer images of the respective colors are sequentially superimposed on the surface of the intermediate transfer belt 44, starting with the developer image of silver (S) on the most upstream side. The intermediate transfer section 40 runs the intermediate transfer belt 44, which causes the developer image transferred from each of the image formation units 10 to reach the vicinity of the backup roller 43.

By the way, a conveyance path W, which is a path for conveying a paper P, is formed inside the housing 2 (FIG. 1). In the housing 2, the conveyance path W extends from near the front lower end of the housing 2 in a front-upward direction, carves about half a turn, and then extends therefrom in the rear direction beneath the intermediate transfer section 40. The conveyance path W extends therefrom in the upper direction along the back sides of the intermediate transfer section 40 and the image formation unit 10S, and then extends in the front direction. In other words, the conveyance path W is formed in like a capital letter “S” in FIG. 1. Inside the housing 2, various parts are arranged along the conveyance path W.

A first paper feed section 50 is disposed near the lower end in the housing 2 (FIG. 1). The first paper feed section 50 is provided with a paper cassette 51, a pickup roller 52, a feed roller 53, a retard roller 54, a conveyance guide 55, and pairs of conveyance rollers 56, 57, and 58, and the like. Note that the pickup roller 52, the feed roller 53, the retard roller 54, and the conveyance rollers 56, 57, and 58 are all formed in a cylindrical shape with a central axis extending along the left-right direction.

The paper cassette 51 is formed in a rectangular shape having a hollow therein, and the paper cassette 51 stores therein the paper P in a stacked state with the paper surfaces of the paper P facing upward and downward, i.e., in an accumulated state. The paper cassette 51 is detachable from the housing 2.

The pickup roller 52 is in contact with a front end portion of an upper surface of an uppermost sheet of paper P in the paper cassette 51. The feed roller 53 is disposed in front of the pickup roller 52 with a short distance therebetween. The retard roller 54 is located below the feed roller 53 and forms a gap equivalent to the thickness of a sheet of paper P between the feed roller 53 and the retard roller 54.

The first paper feed section 50 stops or rotates the pickup roller 52, the feed roller 53, and the retard roller 54 as appropriate when drive power is supplied from a paper feed motor (not illustrated). Thus, the pickup roller 52 forwards one or more of the uppermost sheets of paper P stored in the paper cassette 51. The feed roller 53 and the retard roller 54 further forward only the uppermost one of the forwarded sheets, by stopping the second and lower sheets of the forwarded sheets. Thus, the first paper feed section 50 feeds the paper P in the front direction while separating the sheets of paper P one by one.

The conveyance guide 55 is disposed at the front lower portion in the transfer path W, and causes the paper P to travel along the path W in the front upper direction and then further in the rear upper direction. The conveyance roller pairs 56 and 57 are disposed near the center and near the upper end of the conveyance guide 55, respectively, and are rotated in predetermined directions when the drive power is supplied from the paper feed motor (not illustrated). The conveyance roller pairs 56 and 57 thereby cause the paper P to move along the conveyance path W.

A second paper feed section 60 is also provided on the front side of the conveyance roller pair 57 in the housing 2. The second paper feed section 60 includes a paper tray 61, a pickup roller 62, a feed roller 63, a retard roller 64, and the like. The paper tray 61 is formed in a thin plate shape having a thickness in the vertical direction, and paper P2 is placed on the upper side of the paper tray 61. Note that, the paper P2, which may be different in size or quality from the paper P stored in the paper cassette 51, for example, is placed on the paper tray 61.

The pickup roller 62, the feed roller 63, and the retard roller 64 are configured in the same manner as or a similar manner to the pickup roller 52, the feed roller 53, and the retard roller 54 of the first paper feed section 50, respectively. When drive power is supplied from a paper feed motor (not illustrated), the second paper feed section 60 rotates or stops the pickup roller 62, the feed roller 63, and the retard roller 64 as appropriate, to feed in the rear direction the uppermost sheet of the paper P2 while stopping the second and lower sheets of the paper P2 on the paper tray 61. Thus, the second paper feed section 60 feeds the paper P2 in the rear direction while separating the sheets of the paper P2 one by one. The fed paper P2 is conveyed along the conveyance path W by the conveyance roller pair 57 in the same manner as the paper P. For convenience of explanation, the paper P2 will be hereinafter referred to simply as the paper P without distinguishing the paper P2 from the paper P.

The rotation of the conveyance roller pair 57 is controlled appropriately to exert a frictional force on the paper P, to correct a so-called skew of the paper P with respect to the conveyance direction of the paper P, that is, to align the leading and trailing ends of the paper P along the left-right direction, and then feed the paper in the rear direction. The conveyance roller pair 58 is located on the rear side of the conveyance roller pair 57 with a predetermined distance therefrom, and is rotated in the same manner as the conveyance roller pair 56 and the like, to supply a driving force to the paper P being conveyed along the conveyance path W to cause the paper P to travel further to the rear side along the conveyance path W.

The secondary transfer part 49 of the intermediate transfer section 40, which includes the backup roller 43 and the secondary transfer roller 46, is disposed on the rear side of the transfer roller pair 58. While the predetermined bias voltage is applied to the secondary transfer roller 46 of the secondary transfer part 49, the developer images that are formed by the image formation units 10 and transferred to the intermediate transfer belt 44 are moved toward the secondary transfer part 49 as the intermediate transfer belt 44 runs. Therefore, the secondary transfer part 49 transfers the developer images from the intermediate transfer belt 44 to the paper P being conveyed along the conveyance path W and further conveys the paper P that has the developer images transferred thereon in the rear direction.

In the image formation apparatus 1, on the lower back side of the driven roller 42, a density sensor DS is provided. The density sensor DS detects the densities of the developers in the developer images transferred to the surface of the intermediate transfer belt 44, and notifies the results of the detection obtained to the print controller 3. Accordingly, the print controller 3 performs density correction for correcting the densities of the developers in the developer images of the individual colors formed in the image formation units 10, and performs feedback control on the bias voltages to the individual units and the like such that the densities of the developers are changed to desired values.

A fixation device 65 is located on the rear side of the secondary transfer part 49. The fixation device 65 includes a heating part 66 and a pressurizing part 67 disposed opposite to each other across the conveyance path W. The heating part 66 includes a heating belt formed of an endless belt, a plurality of rollers, a heater that generate heat, and the like inside the heating belt. The pressurizing part 67 is formed as a pressurizing roller in a cylindrical shape in which its center axis is along the left/right direction, and the surface on the upper side is pressed against the surface on the lower side of the heating part 66 to form a nip portion.

Based on the control of the print controller 3, the fixation device 65 heat the heater of the heating part 66 to a predetermined temperature and rotates the rollers of the heating part 66 appropriately to cause the heating belt to travel so as to rotate the heating belt in the direction of arrow R1 and rotate the pressurizing part 67 in the direction of arrow R2. The fixation device 65 receives the paper P on which the developer image has been transferred by the secondary transfer part 49, sandwiches (i.e., nips) the paper P between the heating part 66 and the pressurizing part 67, fixes the developer image on the paper P by applying heat and pressure, and then conveys the paper in the rear direction.

A conveyance roller pair 68 is disposed on the rear side of the fixation device 65, and a switching part 69 is disposed on the rear side of the conveyance roller pair 68. The switching part 69 switches the direction of travel of the paper P to the upper side or the lower side according to the control of the print controller 3. A paper discharge section 70 is provided on the upper side of the switching part 69. The paper discharge section 70 includes a conveyance guide 71 which guides the paper P upwardly along the conveyance path W, and conveyance roller pairs 72, 73, 74 and 75 which face each other across the conveyance path W, and the like.

A reconveyance section 77 is provided below the switching part 69, the fixation device 65, and the secondary transfer part 49. The reconveyance section 77 includes a conveyance guide, a conveyance roller pair (not illustrated), and the like which form a reconveyance path U. The reconveyance path U extends in the lower direction from the lower side of the switching part 69, extends therefrom in the front direction, and then joins the conveyance route W at the downstream side of the conveyance roller pair 57 in the conveyance path W.

When discharging the paper P, the print controller 3 controls the switching part 69 to switch the direction of travel of the paper P to the upper side, that is, to the paper discharge section 70 side. The paper discharge section 70 conveys the paper P received from the switching part 69 upwardly and discharges the paper P from a discharge port 76 to a paper discharge tray 2T. When re-conveying the paper P, the print controller 3 controls the switching part 69 to switch the direction of travel of the paper P to the lower side, that is, to the reconveyance section 77 side. The reconveyance section 77 conveys the paper P received from the switching part 69 along the reconveyance path U, and eventually causes the paper P to reach the downstream side of the conveyance roller pair 57 in the conveyance path W to be conveyed again along the conveyance path W. This allows the image formation apparatus 1 to perform so-called double-sided printing because the paper P is returned to the conveyance path W with the surfaces of the paper P being upside down.

In this way, the image formation apparatus 1 forms the developer images by the image formation units 10, transfers the developer images to the intermediate transfer belt 44, transfers the developer images from the intermediate transfer belt 44 to the paper P by the secondary transfer part 49, and fixes the developer images to the paper P by the fixation device 65, thereby printing the image on the paper P (i.e., forming the image on the paper). For ease of description, in the following description, the developer image formed of the silver developer (glitter developer) is also referred to as a silver developer image (glitter developer image), and the developer image formed of the color developer (non-glitter color developer) is also referred to as a color developer image (non-glitter color developer image).

For example, in the image formation apparatus 1, when the silver developer image of the silver developer and the color developer image of the color developer are sequentially transferred to the intermediate transfer belt 44 in the image formation units 10, these developer images are transferred to the sheet P in the secondary transfer part 49. In this way, the color developer image is adhered to the surface of the sheet P, and the silver developer image is further superimposed on the surface of the color developer image on the sheet P. In other words, the color developer image is positioned between the sheet P and the silver developer image so as to be superimposed with the silver developer image.

In the following description, the color developer image formed of the black developer is referred to as a black developer image, the color developer image formed of the yellow developer is referred to as a yellow developer image, the color developer image formed of the magenta developer is referred to as a magenta developer image and the color developer image formed of the cyan developer is referred to as a cyan developer image. Here, a developer image that is formed of a developer with a saturation of 5 or less and a brightness of 20 or less when measured with a spectrophotometer (SE7700 made by NIPPON DENSHOKU INDUSTRIES Co., Ltd) using a C light source at an angle of 2 degrees is defined as the black developer image.

Furthermore, in the following description, print processing for superimposing the silver developer image on the color developer image may be referred to as glitter superimposition print processing, and a printed product obtained by the glitter superimposition print processing may be referred to as a sliver and color superimposition printed product. Furthermore, in the following description, print processing for forming the color developer image and the silver developer image without superimposing the silver developer image and the color developer image with each other may be referred to as glitter non-superimposition print processing, and a printed product obtained by the glitter non-superimposition print processing is also referred to as a sliver and color non-superimposition printed product. Furthermore, in the following description, print processing using only the silver developer image may be referred to as silver developer print processing, and a printed product obtained by the silver developer print processing may be referred to as a sliver printed product.

Note that the image formation apparatus 1 is configured, by increasing the absolute value of the bias voltage applied to each of the individual units by the control of the print controller 3, to increase the amount of developer formed in the developer image transferred to the sheet P (that is, the adhered amount) (hereinafter referred to as a formed amount on the medium), whereas by decreasing the absolute value of the bias voltage by the control of the print controller 3, to reduce the formed amount on the medium. Further in the image formation apparatus 1 is configured, by increasing the print image density (details of which are described later) of the developer by the control of the print controller 3, to increase the amount of developer formed in the developer image transferred to the sheet P (the formed amount on the medium), whereas by decreasing the print image density by the control of the print controller, to reduce the formed amount on the medium. Furthermore, the image formation apparatus 1 is configured, by increasing a transfer efficiency in the secondary transfer part 49 by the control of the print controller 3, to increase the formed amount of the developer on the medium, whereas by decreasing the transfer efficiency by the control of the print controller 3, to reduce the formed amount of the developer on the medium.

### 2. Control Configuration of Image Formation Apparatus

As illustrated in FIG. 3, the image formation apparatus 1 includes the CPU 23, a memory 19 and a sensor 22. The CPU 23 includes the print controller 3, an interface (an interface unit) 17, a display controller 18, a process controller 80, a development voltage controller 81, a supply voltage controller 82, an exposure controller 83, a transfer voltage controller 84, a motor controller 85 and a data availability determination unit 86.

The print controller 3 controls the entire operation of the image formation apparatus 1. The interface 17 receives, for example, print data transmitted from the external apparatus 20 such as a computer device, and provides the print data to the print controller 3. The display controller 18 controls the display state of a display (a display device) 21 based on an instruction signal from the print controller 3.

The process controller 80 controls the voltages of the individual units such as the image formation units 10. The development voltage controller 81 controls the bias voltage of the development roller 34. The supply voltage controller 82 controls the bias voltages of the first supply roller 32, the second supply roller 33 and the development blade 35. The exposure controller 83 controls the turning on and off of the LED of the LED head 14. The transfer voltage controller 84 controls the bias voltages of the primary transfer rollers 45. The motor controller 85 rotates the photosensitive drums 36 and the like in the predetermined direction.

The data availability determination unit 86 analyzes the print data transmitted from the external apparatus 20 and received by the interface unit 17, and thereby determines whether or not image data to be printed by the image formation units 10 is present.

The data availability determination unit 86 includes a data conversion table 87. The data conversion table 87 converts the received print data into print patterns of the image formation units 10K, 10C, 10M, 10Y and 10S. When the data availability determination unit 86 receives, for example, print data of a color of red 100% in RGB output from commercially available image creation software, the data availability determination unit 86 determines, according to a conversion formula included in the data conversion table 87, that the print data is image data to be printed with magenta (M) 100% and yellow (Y) 100%.

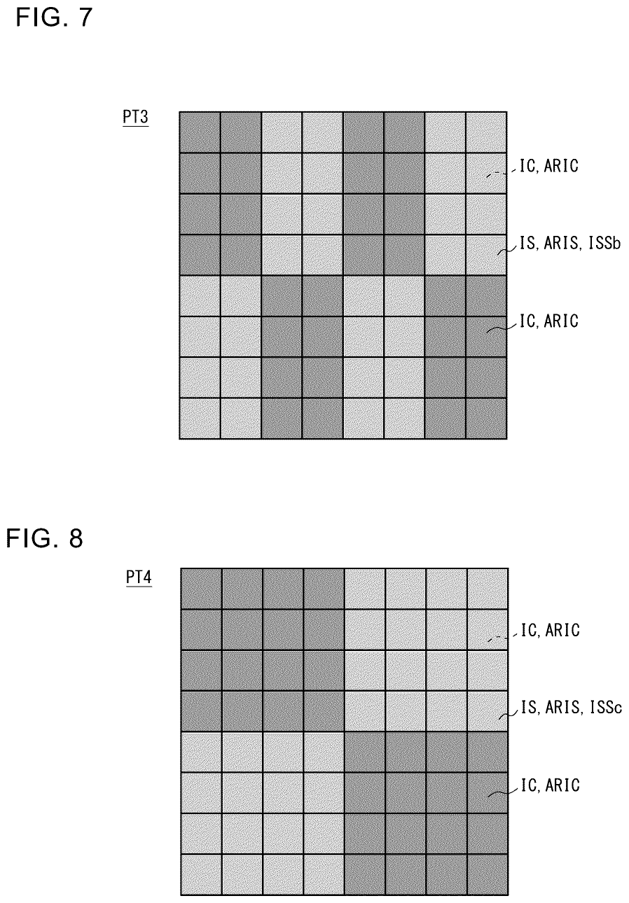

The data availability determination unit 86 further includes a special color silver dedicated data conversion table (a data conversion table dedicated for a special color silver) 88. The special color silver dedicated data conversion table 88 serving as a storage or a storage unit is used when printing color metallic print data. The special color silver dedicated data conversion table 88 includes information that associate the dot count of the image formation unit 10S and print patterns whose numbers of divisions of a silver developer image (described later) are different from each other. When the data availability determination unit 86 receives, for example, print data of a color of silver 100% and cyan 100%, the data availability determination unit 86 determines, according to the conversion formula included in the special color silver dedicated data conversion table 88 and the dot count of the image formation unit 10S, which one of a print pattern PT2 illustrated in FIG. 6, a print pattern PT3 illustrated in FIG. 7, and a print pattern PT4 illustrated in FIG. 8 is to be used to print the image data using silver (S) and cyan (C).

The memory 19 is the ROM and the RAM described above, and stores information indicating the procedure of a printing operation and various types of information (for example, software programs) such as calculation formulas for performing various types of corrections. The memory 19 also includes, for each of the image formation units 10, a dot counter that counts the total of dots printed in the image formation unit 10 after the developer container 12 is mounted. The dot counter memorizes the total number of dots printed by the print controller 3 in each of the image formation units 10. When the print controller 3 sends the image formation unit 10S, for example, an image pattern with a print image density (details of which are described later) of 100% (so-called solid image) on the entire plane of the A4 sheet, the dot count of the image formation unit 10S is increased only by 16384 counts. The sensor 22 performs the detection of the position of the sheet P, the detection of temperature and humidity, and the like.

### 3. Manufacturing of Developer

Next, a method of manufacturing the developer stored in the developer container 12 of the image formation unit 10 (FIG. 2) is described. As the developers of black, yellow, magenta and cyan, commercially available developers for an image formation apparatus (C941dn made by Oki Electric Industry Co., Ltd.) are used. In an embodiment, as the developer of the special color, the silver developer is used. The manufacturing of the silver developer is described below.

In general, a developer includes, in addition to a pigment for expressing a desired color, a binder resin for binding the pigment to a medium such as paper P, external additives for improving the chargeability, and the like. For convenience of explanation, a particle containing a pigment and a binder resin or a powdery substance in which these particles are aggregated is hereinafter referred to as a toner or toner particle, and a powdery substance containing external additives or the like in addition to the toner is referred to as a developer. In an embodiment, since a description is given using a one-component development method, particles including a glitter pigment and a binding resin or a powdery material in which these particles are aggregated is referred to as a glitter toner or glitter toner particles, and a powdery material including an external additive and the like in addition to the glitter toner is defined as a glitter developer. However, when a description is given using a two-component development method, particles including a glitter pigment and a binding resin or a powdery material in which these particles are aggregated is referred to as a glitter toner or glitter toner particles, and a powdery material including an external additive in addition to the glitter toner is defined as a glitter developer.

In an embodiment, an aqueous medium in which an inorganic dispersant is dispersed is first generated. Specifically, 600 parts by weight of industrial trisodium phosphate dodecahydrate are mixed with 18400 parts by weight of pure water and dissolved at a liquid temperature of 60° C., and then dilute nitric acid for pH (hydrogen ion index) adjustment is added, to thus obtain the aqueous solution. To this aqueous solution, a calcium chloride solution, in which 300 parts by weight of industrial calcium chloride anhydride are dissolved in 2600 parts by weight of pure water, is added, and then the solution is stirred at high speed by a line mill (from Primix Corporation) at a rotation speed of 3,566 [rpm] for 50 minutes while maintaining the liquid temperature at 60 [° C.]. In this way, the aqueous phase is adjusted, which is the aqueous medium in which the suspension stabilizer (inorganic dispersant) is dispersed.

In an embodiment, a material dispersion oily medium is generated. Specifically, 470 parts by weight of a glitter pigment (volume average particle diameter of 5.4 μm) and 23 parts by weight of a charge control agent (BONTRON E-84 made by ORIENT CHEMICAL INDUSTRIES CO., LTD.) are mixed with 7000 parts by weight of ethyl acetate, and thus a pigment dispersion liquid is generated. Among them, the glitter pigment contains a minute flake of aluminum (Al), that is, a small piece having a planar part formed in the shape of a flat plate, a flat portion or a scale. In the following description, this glitter pigment is also referred to as an aluminum pigment or a metal pigment. The volume average particle diameter is also referred to as a volume particle diameter, a volume median diameter or an average median diameter. Although in an embodiment, the glitter pigment having a volume average particle diameter of 5.4 μm is used, it may be preferable that the volume average particle diameter of the glitter pigment is in a range of 5.3 to 5.7 μm.

Thereafter, the pigment dispersion liquid is stirred while being maintained at a liquid temperature of 60° C., and 175 parts by weight of ester wax (WE-4 made by NOF Corporation) serving as a release agent and 1670 parts by weight of polyester resin serving as a binder resin are added, and the resulting mixture is stirred until a solid material disappears. In this way, an oil phase that is a pigment dispersion oily medium is prepared.

Then, the oil phase is put into the aqueous phase whose liquid temperature has been lowered to 55° C., and as a granulation condition, the resulting mixture is stirred at a rotation speed of 1000 rpm for 5 minutes so as to be suspended, with the result that particles are formed in the suspension. Next, the suspension is distilled under reduced pressure to remove the ethyl acetate and form a slurry containing the developer. Next, nitric acid is added to the slurry to reduce the pH (hydrogen ion index) to 1.6 or less, and the slurry is stirred to dissolve tricalcium phosphate as a suspension stabilizer, and then dehydrated to form the developer. Then, the dehydrated developer is dispersed and stirred in pure water, to wash the developer. Thereafter, a dehydration process, a drying process and a classification process are carried out to produce toner base particles.

As an external addition step, 1.5 weight % of small silica (RY200 made by NIPPON AEROSIL CO., LTD.), 2.29 weight % of colloidal silica (X24-9163A made by Shin-Etsu Chemical Co., Ltd.) and 0.37 weight % of melamine particles (Epostar S made by NIPPON SHOKUBAI CO., LTD.) are put into and mixed with the toner mother particles generated as described above, with the result that a silver developer having a volume average particle diameter of 15.01 μm is obtained. Although in an embodiment, the silver developer having a volume average particle diameter of 15.01 μm is used, the volume average particle diameter of the silver developer is preferably in a range of 15.01±3.00 μm.

In an embodiment, the volume average particle diameter of the developer is measured using a precision particle size distribution measuring device Multisizer 3 (made by Beckman Coulter, Inc.). The measurement conditions are as follows. Aperture diameter: 100 μm, ⋅Electrolyte: Isoton II (made by Beckman Coulter, Inc.) ⋅Dispersion liquid: Neogen S-20F (made by DKS Co. Ltd.) is dissolved in the electrolyte described above such that its concentration is adjusted to be 5%. In an embodiment, 10 to 20 [mg] of the measurement sample is added to 5 [mL] of the dispersion liquid described above, the resulting mixture is dispersed using an ultrasonic disperser for 1 minute, thereafter 25 [mL] of the electrolyte is added, the resulting mixture is dispersed using the ultrasonic disperser for 5 minutes and an aggregate is removed through a mesh with an opening of 75 μm, with the result that a sample dispersion liquid is prepared. Furthermore, in an embodiment, this sample dispersion liquid is added to 100 [mL] of the electrolyte described above, 30,000 particles are measured and its distribution (that is, a volume particle size distribution) is determined using the precision particle size distribution measuring device described above, with the result that the volume average particle diameter (Dv50) is determined based on the volume particle size distribution. Note that the volume average particle diameter (Dv50) refers to a particle diameter when in the particle size distribution of a powder, the number or mass larger than a certain particle diameter accounts for 50% of the number or mass of the entire powder. The aforementioned precision particle size analyzer measures the particle size distribution using the Coulter principle. The Coulter principle, called the pore electrical resistance method, is a method for measuring the volume of particles by applying a constant electric current through pores (apertures) in an electrolyte solution and measuring the change in an electrical resistance of the pores as the particles pass through them.

### 4. Print Pattern

Next, print patterns are described.

### 4-1. Print Pattern PT1

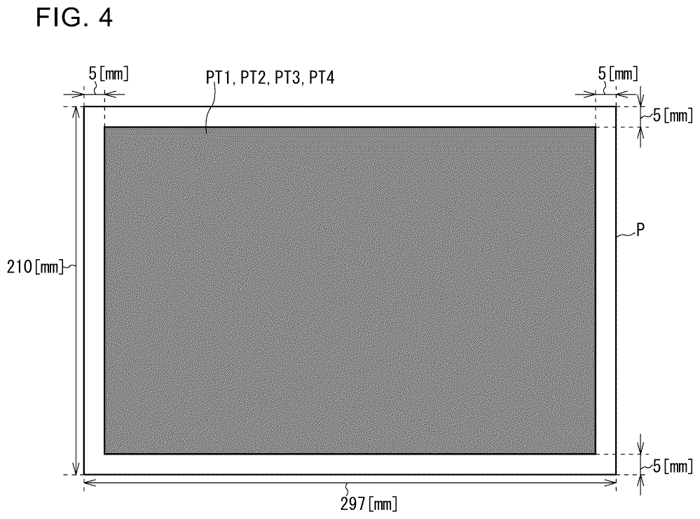

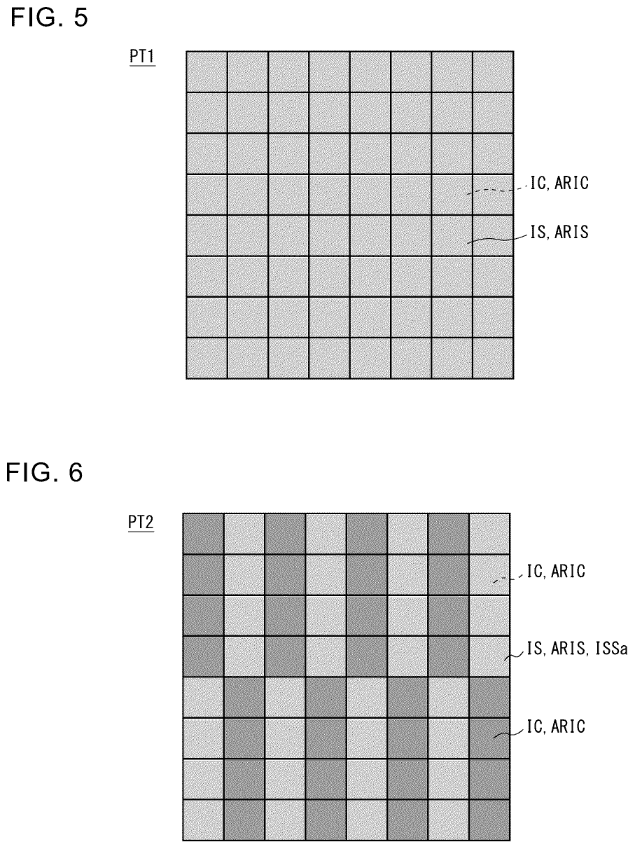

Based on print data that is received from the external apparatus 20 and includes a solid image (that is, an image pattern of a print image density of 100%) of the special color (silver) and a solid image (that is, an image pattern of a print image density of 100%) of the cyan color specified over the entire area of the A4 sheet P, the image formation apparatus 1 produces a print pattern PT1 on the sheet P as illustrated in FIG. 4, by performing a glitter superimposition print processing that prints the solid image of the cyan developer (a cyan developer image IC) under the solid image of the silver developer (a silver developer image IS) without using the special color silver dedicated data conversion table 88. In the case of the print pattern PT1, patterns same as the enlarged view of the print pattern PT1 illustrated in FIG. 5 are spread over the entire area of the A4 sheet P as illustrated in FIG. 4, and thus a sliver and color superimposition printed product is obtained.

The print pattern PT1 is composed of the silver developer image IS which is formed of the silver developer and the cyan developer image IC which is formed of the cyan developer. In the following description, the region of the silver developer image IS on the plane of the sheet is referred to as a silver developer image region ARIS, and the region of the cyan developer image IC is referred to as a cyan developer image region ARIC. In the print pattern PT1, the entire area of the cyan developer image area ARIC overlaps with the silver developer image area ARIS.

When the print pattern PT1 is viewed in an area of 8×8 dots (hereinafter also referred to as a unit area), the silver developer image IS corresponding to 64 dots in all regions of 8 by 8 dots are formed. Here, one dot (also referred to as one pixel unit) refers to a state where the print pattern PT1 is enlarged to the minimum unit of a print command. The print pattern PT1 is formed with dots of 600 dpi, and the smallest square illustrated in FIG. 5 corresponds to one dot. Since the print pattern PT1 is of 600 dpi, the width and the height of one dot are 0.042 mm.

Since in the print pattern PT1, the silver developer images IS corresponding to 64 dots out of 64 dots are formed, the print pattern PT1 is also said to be a print pattern in which the area occupancy ratio of the silver developer images IS (also referred to as a silver developer image area occupancy ratio) is 100%. Further, since in the print pattern PT1, the cyan developer images IC corresponding to 64 dots out of 64 dots are formed, the print pattern PT1 is also said to be a print pattern in which the area occupancy ratio of the cyan developer images IC (also referred to as a cyan developer image area occupancy ratio) is 100%. Accordingly, the print pattern PT1 is the print pattern with the silver developer image area occupancy ratio of 100% and the cyan developer image area occupancy ratio of 100%.

### 4-2. Print Pattern PT2

Based on print data that is received from the external apparatus 20 and includes a solid image of the special color (silver) and a solid image of the cyan color specified over the entire area of the A4 sheet P, the image formation apparatus 1 produces a print pattern PT2 on the sheet P as illustrated in FIG. 4, by performing a glitter superimposition print processing with using the special color silver dedicated data conversion table 88. In the case of the print pattern PT2, patterns same as the enlarged view of the print pattern PT2 illustrated in FIG. 6 are spread over the entire area of the A4 sheet P as illustrated in FIG. 4, and thus a sliver and color superimposition printed product is obtained.

In the silver developer image IS, silver developer image rectangles ISSa, each of which is a rectangle of 4 dots in the vertical direction and 1 dot in the horizontal direction, are arranged in a grid pattern with intervals of 4 dots in the vertical direction and 1 dot in the horizontal direction. All the silver developer image rectangles ISSa overlap with the cyan developer image IC. The image formation apparatus 1 performs a glitter superimposition print processing that prints the silver developer image IS on the cyan developer image IC that is the solid image of the cyan developer, and thereby forms regions where the cyan developer image IC and the silver developer image IS are overlapped with each other.

Since in the print pattern PT2, the silver developer image IS corresponding to 32 dots out of 64 dots is formed in the unit area, the print pattern PT2 is also said to be a print pattern with a silver developer image area occupancy ratio of 50%. Since in the print pattern PT2, the cyan developer image IS corresponding to 64 dots out of 64 dots is formed in the unit area, the print pattern PT2 is also said to be a print pattern with a cyan developer image area occupancy ratio of 100%. Accordingly, the print pattern PT2 is the print pattern with the silver developer image area occupancy ratio of 50% and the cyan developer image area occupancy ratio of 100%.

Also, when the print pattern PT2 is viewed in the unit area (the area of 8×8 dots), eight silver developer image squires ISSa, each of which is formed in a same manner of 4 dots of silver developer image region ARIS, are arranged. Therefore, when the print pattern PT2 is viewed in the unit area, 32 dots of the silver developer image region ARIS in the unit area of the print pattern PT2 is divided into eight silver developer image rectangles ISSa, each of which has 4 dots. In other words, it can be said that in the print pattern PT2, the number of divisions of the silver developer image IS per unit area of 8×8 dots is eight.

### 4-3. Print Pattern PT3

Based on print data that is received from the external apparatus 20 and includes a solid image of the special color (silver) and a solid image of the cyan color specified over the entire area of the A4 sheet P, the image formation apparatus 1 produces a print pattern PT3 on the sheet P as illustrated in FIG. 4, by performing a glitter superimposition print processing with using the special color silver dedicated data conversion table 88. In the case of the print pattern PT3, patterns same as the enlarged view of the print pattern PT3 illustrated in FIG. 7 are spread over the entire area of the A4 sheet P as illustrated in FIG. 4, and thus a sliver and color superimposition printed product is obtained.

In the silver developer image IS, silver developer image rectangles ISSa, each of which is a rectangle of 4 dots in the vertical direction and 2 dots in the horizontal direction, are arranged in a grid pattern with intervals of 4 dots in the vertical direction and 2 dots in the horizontal direction. Therefore, the width of the silver developer image rectangle ISSb is twice that of the silver developer image rectangle ISSa. All the silver developer image rectangles ISSb overlap with the cyan developer image IC.

Since in the print pattern PT3, as in the print pattern PT2, the silver developer image IS corresponding to 32 dots out of 64 dots is formed and the cyan developer image IC corresponding to 64 bits out of 64 dots is formed, the print pattern PT3 is a print pattern with a silver developer image area occupancy ratio of 50% and a cyan developer image area occupancy ratio of 100%.

Also, when the print pattern PT3 is viewed in the unit area (the area of 8×8 dots), four silver developer image squires ISSb, each of which is formed in a same manner of 8 dots of silver developer image region ARIS, are arranged. Therefore, when the print pattern PT3 is viewed in the unit area, 32 dots of the silver developer image region ARIS in the unit area of the print pattern PT3 is divided into four silver developer image rectangles ISSa, each of which has 8 dots. In other words, it can be said that in the print pattern PT3, the number of divisions of the silver developer image IS per unit area of 8×8 dots is four.

### 4-4. Print Pattern PT4

Based on print data that is received from the external apparatus 20 and includes a solid image of the special color (silver) and a solid image of the cyan color specified over the entire area of the A4 sheet P, the image formation apparatus 1 produces a print pattern PT4 on the sheet P as illustrated in FIG. 4, by performing a glitter superimposition print processing with using the special color silver dedicated data conversion table 88. In the case of the print pattern PT4, patterns same as the enlarged view of the print pattern PT4 illustrated in FIG. 8 are spread over the entire area of the A4 sheet P as illustrated in FIG. 4, and thus a sliver and black superimposition printed product is obtained.

In the silver developer image IS, silver developer image rectangles ISSc, each of which is a rectangle of 4 dots in the vertical direction and 4 dots in the horizontal direction, are arranged in a grid pattern with intervals of 4 dots in the vertical direction and 4 dot in the horizontal direction. Therefore, the width of the silver developer image rectangle ISSc is twice that of the silver developer image rectangle ISSb. All the silver developer image rectangles ISSc overlap with the cyan developer image IC. Hereinafter, the silver developer image quadrangles ISSa, ISSB, and ISSc may be referred to as the silver developer image quadrangle ISS.

Since in the print pattern PT4, as in the print pattern PT2 and the print pattern PT3, the silver developer image IS corresponding to 32 dots out of 64 dots is formed and the cyan developer image IC corresponding to 64 bits out of 64 dots is formed, the print pattern PT4 is a print pattern with a silver developer image area occupancy ratio of 50% and a cyan developer image area occupancy ratio of 100%.

Also, when the print pattern PT4 is viewed in the unit area (the area of 8×8 dots), two silver developer image squires ISSb, each of which is formed in a same manner of 16 dots of silver developer image region ARIS, are arranged. Therefore, when the print pattern PT4 is viewed in the unit area, 32 dots of the silver developer image region ARIS in the unit area of the print pattern PT4 is divided into two silver developer image rectangles ISSc, each of which has 16 dots. In other words, it can be said that in the print pattern PT4, the number of divisions of the silver developer image IS per unit area of 8×8 dots is two.

### 4-5. Print Image Density

Here, the print image density refers to a value that indicates, when an image is decomposed pixel by pixel, a ratio of the number of pixels in which a developer is transferred to the sheet P to the total number of pixels. For example, printing with an area ratio of 100% when full-surface solid printing is performed in a printable range of a predetermined region (such as a region corresponding to one revolution of the photosensitive drum 36 or a region corresponding to one page of a print medium) refers to a print image density of 100%, and printing corresponding to an area of 1% relative to the print image density of 100% refers to a print image density of 1%. When a print image density DPD is represented by a formula using the number of used dots Cm, the number of revolutions Cd and the total number of dots CO, the print image density DPD can be represented by formula (1) below.

$$\begin{matrix}[ Formula 1 ] & \\ DPD = Cm / ( Cd \times CO ) \times 100 \% & ( 1 )\end{matrix}$$

Note that the number of used dots Cm is the number of dots actually used to form an image while the photosensitive drum 36 is being rotated Cd revolutions, and the number of used dots Cm is the total number of dots exposed by the LED head 14 (FIG. 2) during the formation of the image. The total number of dots CO is the total number of dots per revolution of the photosensitive drum 36 (FIG. 2), that is, the total number of dots which can be used while the photosensitive drum 36 is being rotated one revolution or can be potentially used for forming an image regardless of whether exposure is performed. In other words, the total number of dots CO is the total value of the number of used dots when a solid image in which a developer is transferred to all pixels is formed. Hence, the value (Cd×CO) represents the total value of the number of dots that can be potentially used for forming an image while the photosensitive drum 36 rotates Cd times.

### 5. Measurement and Evaluation of Developer

### 5-1. Measurement of Developer

Next, the measurement and the evaluation of a developer are described. In the measurement and the evaluation of the developer, the image formation apparatus 1 (FIG. 1) uses the developer to print a predetermined image on the sheet P, and the measurement and the evaluation of a luster are performed.

In the evaluation, the image formation apparatus 1 (C941dn made by Oki Electric Industry Co., Ltd.) (FIG. 1), which stores the silver developer in the developer container 12 (FIG. 2) of the image formation unit 10S for the special color and the cyan developer in the developer container 12 (FIG. 2) of the image formation unit 10C for the cyan color, performs print processing of Example 1, Comparative Example 1, Comparative Example 2, Comparative Example 3, and Comparative Example 4. Then, the evaluation of a luster on the printed products is performed.

Specifically, in the evaluation, as the sheet P, coated paper (OS coated paper W·127 [g/m2] made by Fuji Xerox Co., Ltd.) is used. In the evaluation, printing is performed by adjusting the bias voltage in the image formation unit 10S such that the luminous reflectance difference ΔY (described later) of the silver developer image IS is 33 when an image pattern (so-called solid image) with the print image density of silver set to 100% is printed on the entire area of the A4 sheet P as illustrated in FIG. 4. Furthermore, in the evaluation, likewise for cyan, printing is performed by adjusting the bias voltage in the image formation unit 10C such that the optical density (O.D. value) of the cyan developer image IC is 1.4 when an image pattern (so-called solid image) with the print image density of cyan set to 100% is printed on the entire area of the A4 sheet P.

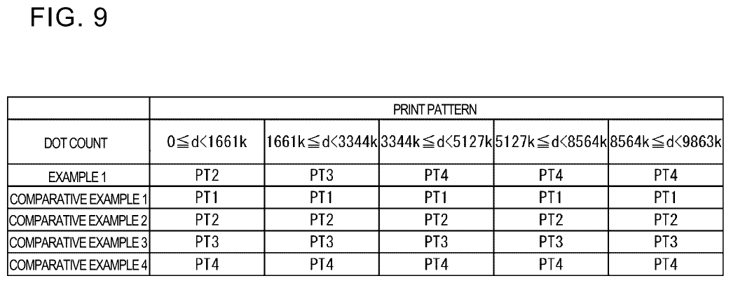

In Example and Comparative Examples, the image formation apparatus 1 performs, based on print data in which solid images of silver and cyan are specified on the entire area of the A4 sheet P transmitted from the external apparatus 20, printing a different print pattern for each of the Examples and Comparative Examples, as illustrated in FIG. 9. As illustrated in FIG. 9, Example and Comparative Examples differ in into which one of the print patterns PT1 to PT4 the print data in which the solid images of silver and cyan are specified is converted by the image formation apparatus 1 according to the value of the dot count d of the image formation unit 10S. In the following description, print patterns PT1, PT2, PT3, and PT4 are collectively referred to as print patterns PT.

To develop each of the print patterns PT1 to PT4, the LED head 14 (FIG. 2) controls the output of each dot based on the print pattern into an on state and an off state, such that the bits (dots) in the on state are developed with the developer while the bits (dots) in the off state are not developed with the developer.

As described above, when the image formation apparatus 1 receives print data in which silver and cyan solid images are specified in the image creation software from the external apparatus 20, if the special color silver dedicated data conversion table 88 is not used, the image formation apparatus 1 performs printing with print patterns in which the entire area of the cyan developer image area ARIC overlaps with the silver developer image area ARIS as illustrated in the print pattern PT1 (FIG. 5), whereas if the special color silver data conversion table 88 is used, the image formation apparatus 1 performs printing with print patterns PT in which a part of the cyan developer image area ARIC overlaps the silver developer image area ARIS and of which the numbers of divisions of the silver developer image IS are different from each other.

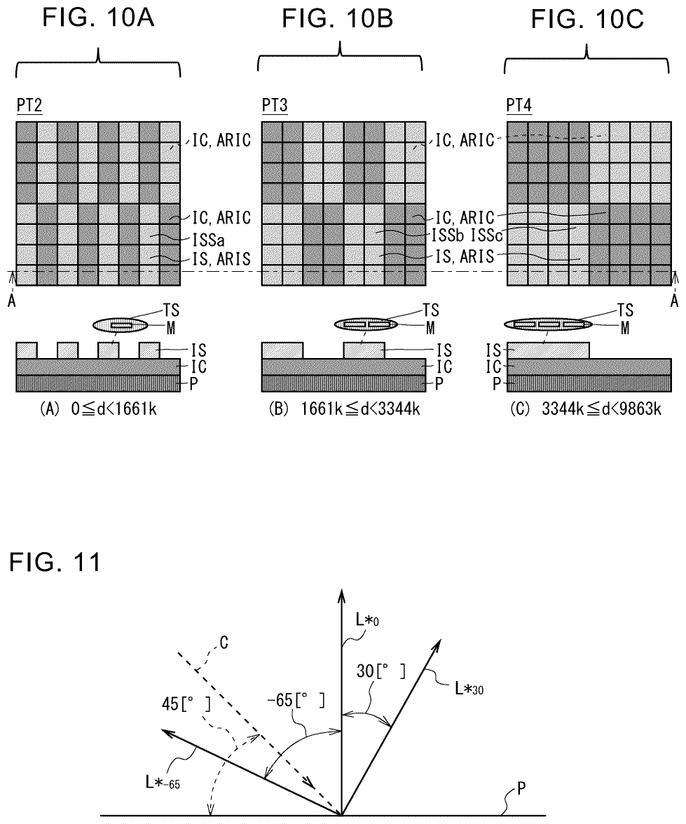

For example, in Example 1, the print pattern PT2 (FIG. 6) is used when the dot count d of the image formation unit 10S is 0 or more and less than 1161 k counts (that is, 1661000 counts) as illustrated in FIG. 10A, the print pattern PT3 (FIG. 7) is used when the dot count d of the image formation unit 10S is 1661 k counts or more and less than 3344 k counts (that is, 3344000 counts) as illustrated in FIG. 10B, and the print pattern PT4 (FIG. 8) is used when the dot count d of the image formation unit 10S is 3344 k counts or more and less than 9863 k counts (that is, 9863000 counts) as illustrated in FIG. 10C. As described above, Example 1 is characterized in that the print pattern PT is changed among the print pattern PT2, the print pattern PT3, and the print pattern PT4 as the dot count d of the image formation unit 10S is increased.

As illustrated in FIG. 9, in Comparative Example 1, regardless of the dot count d of the image formation unit 10S, only the print pattern PT1 (FIG. 5), in which the silver developer image IS with the print image density of 100% and the cyan developer image IC with the print image density of 100% are overlapped, is printed, and is the same as in normal color metallic printing. Comparative Example 2, Comparative Example 3, and Comparative Example 4 are those in which only the print pattern PT2, print pattern PT3, and print pattern PT4 are printed, respectively, regardless of the dot count d of the image formation unit 10S.

### 5-2. Printed Product Acquisition Procedure

Here, a description is given of a procedure for acquiring a printed product that is used in the evaluation described later.

(Procedure 1) The image formation apparatus 1 (C941dn made by Oki Electric Industry Co., Ltd.) is prepared in which the dot count d of the image formation unit 10S is 0. Then, the image formation apparatus 1 performs, based on the print data in which the solid images of silver and cyan are specified on the entire area of the A4 sheet P, printing the solid image (FIG. 4) in which the print pattern PT specified by each of Example and Comparative Examples are spread over the entire area of the A4 sheet, on one sheet P for each of Example and Comparative Examples.

(Procedure 2) The luster and color gamut of the printed product that is acquired is measured.

(Procedure 3) The image formation apparatus 1 performs, based on the print data in which the solid image of silver is specified on the entire area of the A4 sheet P, printing of the solid image (FIG. 4) in which the print pattern PT specified in each of Example and Comparative Examples are spread over the entire area of the A4 sheet P, on a predetermined number of sheets P for each of the print patterns PT, until the dot count d of the Image formation unit 10S reaches 166 k counts.

(Procedure 4) The image formation apparatus 1 whose dot count d of the image formation unit 10S is 1661 k counts, performs, based on the print data in which the solid images of silver and cyan are specified on the entire area of the A4 sheet P, printing the solid image (FIG. 4) in which the print pattern PT specified by each of Example and Comparative Examples are spread over the entire area of the A4 sheet P, on one sheet P for each of Example and Comparative Examples.

(Procedure 5) The luster and color gamut of the printed product that is acquired is measured.

(Procedure 6) The image formation apparatus 1 performs, based on the print data in which the solid image of silver is specified on the entire area of the A4 sheet P, printing of the solid image (FIG. 4) in which the print pattern PT specified in each of the Examples and Comparative Examples are spread over the entire area of the A4 sheet P, on a predetermined number of sheets P for each of the print patterns PT, until the dot count d of the Image formation unit 10S reaches 3344 k counts.

(Procedure 7) The image formation apparatus 1 whose dot count d of the image formation unit 10S is 3344 k counts, performs, based on the print data in which the solid images of silver and cyan are specified on the entire area of the A4 sheet P, printing the solid image (FIG. 4) in which the print pattern PT specified by each of Example and Comparative Examples are spread over the entire area of the A4 sheet P, on one sheet P for each of Example and Comparative Examples.

(Procedure 8) The luster and color gamut of the printed product that is acquired is measured.

(Procedure 9) The image formation apparatus 1 performs, based on the print data in which the solid image of silver is specified on the entire area of the A4 sheet P, printing of the solid image (FIG. 4) in which the print pattern PT specified in each of Examples and Comparative Examples are spread over the entire area of the A4 sheet P, on a predetermined number of sheets P for each of the print patterns PT, until the dot count d of the image formation unit 10S reaches 5127 k counts.

(Procedure 10) The image formation apparatus 1 whose dot count d of the image formation unit 10S is 5127 k counts, performs, based on the print data in which the solid images of silver and cyan are specified on the entire area of the A4 sheet P, printing the solid image (FIG. 4) in which the print pattern PT specified by each of Example and Comparative Examples are spread over the entire area of the A4 sheet P, on one sheet P for each of Example and Comparative Examples.

(Procedure 11) The luster and color gamut of the printed product that is acquired is measured.

(Procedure 12) The image formation apparatus 1 performs, based on the print data in which the solid images of silver and cyan are specified on the entire area of the A4 sheet P, printing of the solid image (FIG. 4) in which the print pattern PT specified in each of the Examples and Comparative Examples are spread over the entire area of the A4 sheet P, on a predetermined number of sheets P, until the dot count d of the image formation unit 10S reaches 8564 k counts.

(Procedure 13) The image formation apparatus 1 whose dot count d of the image formation unit 10S is 8564 k counts, performs, based on the print data in which the solid images of silver and cyan are specified on the entire area of the A4 sheet P, printing the solid image (FIG. 4) in which the print pattern PT specified by each of Example and Comparative Examples are spread over the entire area of the A4 sheet P, on one sheet P for each of Example and Comparative Examples.

(Procedure 14) The luster and color gamut of the printed product that is acquired is measured.

(Procedure 15) The image formation apparatus 1 performs, based on the print data in which the solid images of silver and cyan are specified on the entire area of the A4 sheet P, printing of the solid image (FIG. 4) in which the print pattern PT specified in each of Examples and Comparative Examples are spread over the entire area of the A4 sheet P, on a predetermined number of sheets P, until the dot count d of the image formation unit 10S reaches 9863 k counts.

(Procedure 16) The image formation apparatus 1 whose dot count d of the image formation unit 10S is 9863 k counts, performs, based on the print data in which the solid images of silver and cyan are specified on the entire area of the A4 sheet P, printing the solid image (FIG. 4) in which the print pattern PT specified by each of Example and Comparative Examples are spread over the entire area of the A4 sheet P, on one sheet P for each of Example and Comparative Examples.

(Procedure 17) The luster of the printed product that is acquired is measured. Although the evaluation is completed when the dot count d reaches 9863 k counts, this is because the developer in the developer storage space 31 of the image formation unit 10S runs out, and the count at which the developer in the image formation unit 10S also runs out is reached.

### 5-3. Measurement of Hue

In this measurement, using a spectrophotometer (CM-2600d, measuring meter φ=8 mm: made by KONICA MINOLTA, INC.), a luminous reflectance difference ΔY is measured as a measurement value that indicates a silver hue (grayness) on the plane of the sheet. The luminous reflectance difference ΔY refers to a difference between the luminous reflectance of a blank sheet and the luminous reflectance of a print image. Specifically, the luminous reflectance difference ΔY is measured by subtracting the luminous reflectance of a medium before printing from the luminous reflectance of the medium after printing. As the underlay of a printed product during the measurement, coated paper (OS coated paper W·127 g/m2 made by Fuji Xerox Co., Ltd.) serving as the medium before printing is used. As a light source condition, C is used, as an angle, 2 degrees is used and as a specular reflection light processing method, SCE is used.

Here, as the characteristic of the silver developer, the silver developer can show not only its own glitter in the printed product but also its own grayness as a color tone. However, for the grayness, when the luminous reflectance difference ΔY is excessively low so as to be less than 30, that is, when the color tone is similar to the original medium, the gray color tone disappears, and thus the grayness cannot be shown. On the other hand, when the luminous reflectance difference ΔY is excessively high so as to exceed 36, the color is excessively dark, and thus a black color tone is strong, with the result that the grayness cannot be likewise show. Hence, in this evaluation, when the luminous reflectance difference ΔY is equal to or greater than 30 and equal to or less than 36, it is considered that the grayness of the silver developer after printing can be shown. Therefore, the luminous reflectance difference ΔY at one measurement part in any one place in the A4 sheet P is measured, and the bias voltage in the image formation unit 10S is adjusted such that the luminous reflectance difference ΔY is 33, which is equal to or greater than 30 and equal to or less than 36.

### 5-4. Measurement of Density

In this measurement, a spectrophotometer (X-Rite exact made by X-Rite, Incorporated.) is used with a D50 light source, an angle of 2 degrees, and a status being set to status I, to measure the optical density (O.D. value) of the cyan developer image IC at an arbitrary point on the A4 sheet P as a measurement value indicating the hue of cyan on the plane of the sheet, and the bias voltage in the image formation unit 10S is adjusted such that the optical density is 1.4.

### 5-5. Measurement and Evaluation of Color Gamut

In this evaluation, a spectrophotometer (X-Rite eXact: manufactured by X-Rite Co., Ltd.) is used with a D50 light source, an angle of 2 degrees, and a status I setting, to measure the color gamut of the cyan developer image IC at an arbitrary point on the A4 paper sheet P. The color gamut is expressed using C*, which indicates saturation in the color space, and C* is calculated based on a* and b* that can be measured with the spectrophotometer according to the following formula.

$${C}^{⋆} = {( {a}^{⋆ 2} + {b}^{⋆ 2} )}^{1 / 2}$$

Since the C* value of cyan 100% is 60, it is assumed that the closer the C* value of the color metallic is to 60, the wider the color gamut. When the C* value is 30 or more, a sufficiently vivid cyan color can be perceived by the naked eye. Therefore, in the printed product obtained in any one of Example and Comparative Examples, if the C* value at the dot counts d of 0, 1661 k, 3344 k, 5127 k, 8564 k, and 9863 k (that is, at all of the dot counts d) are 30 or more, it is determined that C* (i.e., color gamut) is good. In addition, in the printed product obtained in any one of Example and Comparative Examples, if the standard deviations of the C* value at all of the dot counts d (=0, 1661 k, 3344 k, 5127 k, 8564 k, and 9863 k) are smaller than that of Comparative Example 1, it is determined that the stability of the C* value is good.

### 5-6. Measurement and Evaluation of Luster

Next, in this evaluation, a glittering property is measured using a variable angle photometer (GC-5000L made by NIPPON DENSHOKU INDUSTRIES Co., Ltd). Specifically, as illustrated in FIG. 11, using the variable angle photometer, a light beam C is emitted from a direction of 45 degrees relative to the surface of the sheet P to the sheet P, reflected light is individually received in a direction of 0 degree, in a direction of 30 degrees and in a direction of −65 degrees and based on the results of the light reception obtained, a brightness index L*0, a brightness index L*30 and a brightness index L*−65 are calculated. Next, in this evaluation, the flop index FI is calculated by substituting each calculated brightness index into the following equation (2), so as to calculate the glitter of the image.

$$\begin{matrix}[ Formula 2 ] & \\ FI = 2.69 \times {( {L}_{30}^{⋆} - {L}_{- 65}^{⋆} )}^{1.11} / {( {L}_{0}^{⋆} )}^{0.86} & ( 2 )\end{matrix}$$

The flop index FI (FI value) is an index that indicates a luster, and as the value is higher, the glittering property is higher whereas as the value is lower, the glittering property is lower. Here, when the FI value is equal to or greater than 10.0, it visually appears that the printed product has a metallic luster. Hence, in this evaluation, when the FI value is equal to or greater than 10.0, it is considered that a sufficient gritter is obtained. Therefore, the FI value of any one measurement point on the A4 paper P is measured, and when the FI value is 10.0 or more, it is determined that the glossiness is good. That is, in the printed product obtained in any one of Example and Comparative Examples, when the FI values at all of dot counts d (=0, 1661 k, 3344 k, 5127 k, 8564 k, and 9863 k) are 10.0 or more, the FI value (i.e., glossiness) thereof is determined to be good.

In addition, among the printed products obtained in Example and Comparative Examples, those having good glossiness and color gamut at all of the dot counts d are determined to have both of the glossiness and the color gamut being good. In addition, in the printed product obtained in any one of Example and Comparative Examples, if the standard deviations of the FI values at all of the dot counts d (=0, 1661 k, 3344 k, 5127 k, 8564 k, and 9863 k) are smaller than that of Comparative Example 1, it is determined that the stability of the FI value is good.

### 6. Measurement Results and Evaluation Results

The results of the evaluation tests for confirming the effects of the Examples and effects that are found from the results are described below.

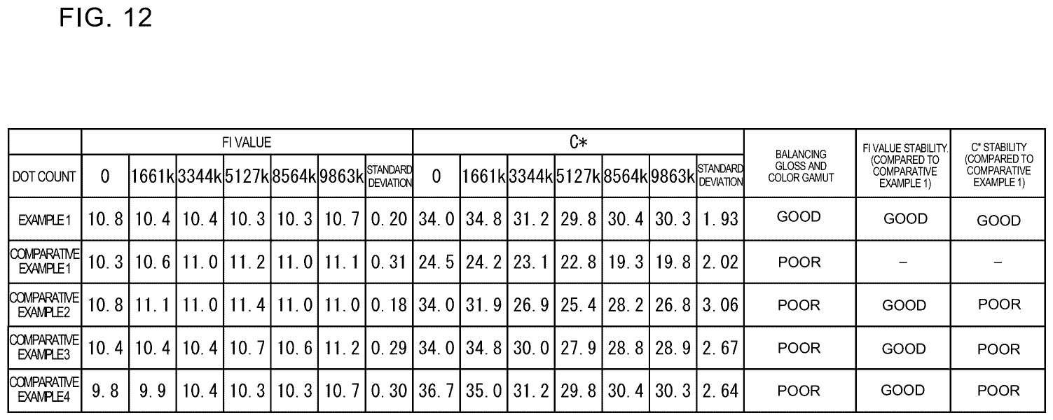

As illustrated in FIG. 12, when the dot count d is 0, the glossiness of each of Example 1, Comparative Example 1, Comparative Example 2, and Comparative Example 3 is determined to be good because the FI value is 10.0 or more. Further, when the dot count d is 0, the color gamut of each of Example 1, Comparative Example 3, and Comparative Example 4 is determined to be good because the C* value is 30 or more. Therefore, when the dot count d is 0, both glossiness and color gamut of each of Example 1, Comparative Example 2, and Comparative Example 3 are satisfactory.

When the dot count d is 1661 k, the glossiness of each of Example 1, Comparative Example 1, Comparative Example 2, and Comparative Example 3 is determined to be good because the FI value thereof is 10.0 or more. Further, when the dot count d is 1661 k, the color gamut of each of Example 1, Comparative Example 3, and Comparative Example 4 is determined to be good because the C* value thereof is 30 or more. Therefore, when the dot count d is 1661 k, both of the glossiness and the color gamut of each of Example 1, Comparative Example 2, and Comparative Example 3 are satisfactory.

When the dot count d is 3344 k, each of Example 1, Comparative Example 1, Comparative Example 2, Comparative Example 3, and Comparative Example 4 has a good glossiness because the FI value is 10.0 or more. Further, when the dot count d is 3344 k, each of Example 1, Comparative Example 3, and Comparative Example 4 has a good color gamut because the C* value is 30 or more. Therefore, when the dot count d is 3344 k, both of the glossiness and the color gamut of each of Example 1, Comparative Example 3, and Comparative Example 4 are satisfactory.

When the dot count d is 5127 k, each of Example 1, Comparative Example 1, Comparative Example 2, Comparative Example 3, and Comparative Example 4 has a good glossiness because the FI value is 10.0 or more. Further, when the dot count d is 5127 k, the C* value in Example 1, Comparative Example 1, Comparative Example 2, Comparative Example 3, and Comparative Example 4 are less than 30, but the C* value in Example 1 and Comparative Example 4 are close to 30. Therefore, when the dot count d is 5127 k, both of the glossiness and the color gamut of each of Example 1 and Comparative Example 4 are substantially satisfactory.

When the dot count d is 8564 k, each of Example 1, Comparative Example 1, Comparative Example 2, Comparative Example 3, and Comparative Example 4 has a good glossiness because the FI value is 10.0 or more. Further, when the dot count d is 8564 k, each of Example 1 and Comparative Example 4 has a good color gamut because the C* value is 30 or more. Therefore, when the dot count d is 8564 k, both of the glossiness and the color gamut of each of Example 1 and Comparative Example 4 are satisfactory.

When the dot count d is 9863 k, each of Example 1, Comparative Example 1, Comparative Example 2, Comparative Example 3, and Comparative Example 4 has a good glossiness because the FI value thereof is 10.0 or more. Further, when the dot count d is 9863 k, each of Example 1 and Comparative Example 4 has a good color gamut because the C* value thereof is 30 or more. Therefore, when the dot count d is 9863 k, both of the glossiness and the color gamut of each of Example 1 and Comparative Example 4 are satisfactory.

From the above results, only Example 1 obtains good FI values and high C* values at all of the dot counts d (=0, 1661 k, 3344 k, 5127 k, 8564 k, and 9863 k) and thus achieves both of the high glossiness and the wide color gamut. In addition, in Example 1, the standard deviation of the FI value and the standard deviation of the C* value are smaller than in Comparative Example 1, and the FI value and the C* value are more stable than in Comparative Example 1 which is a conventional method. Accordingly, by performing printing in the method according to Example 1, the image formation apparatus 1 can obtain a printed product that has a stable metallic luster (FI value) and a stable color gamut (saturation C*) from the start of use of the silver developer in the image formation unit 10S (that is, in the early stage of printing) until the end of use of the silver developer (that is, the late stage of printing).

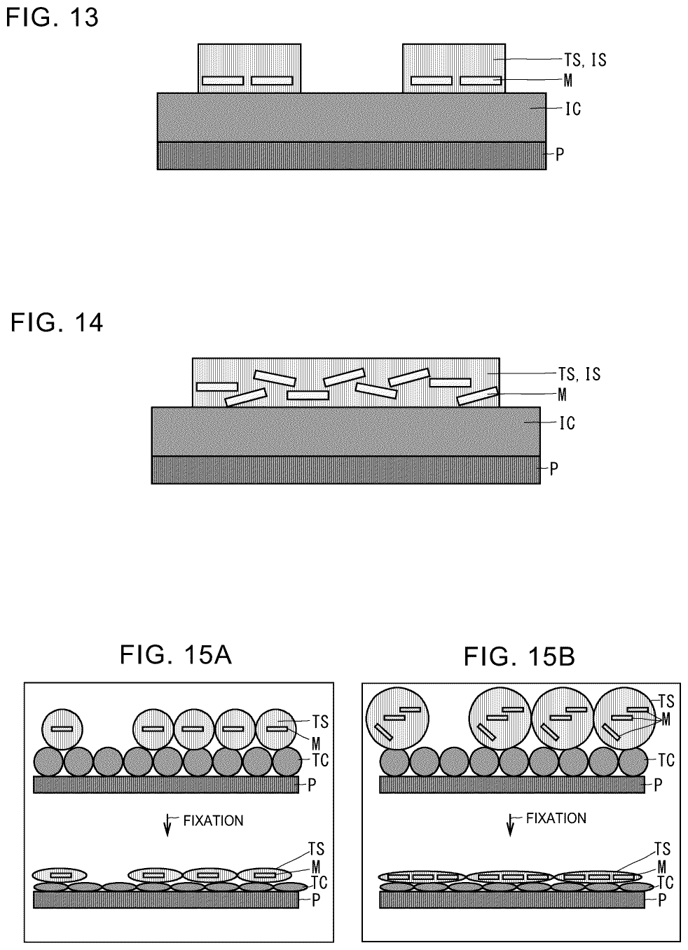

The reason why the FI value is stable in Example 1 from the start of use to the end of use of the silver developer in the image formation unit 10S is described below. The reason why the FI value is stable is that by changing the print pattern PT, the orientation of the silver pigment M is changed as illustrated in FIGS. 13 and 14. A part of the silver developer TS that is present at the end portions (i.e., edge portions) of the silver developer image IS, that is, the silver developer image rectangles ISS (FIG. 10) in plan view, has a space to spread in the surface direction along the paper surface of the paper P and thus tends to spread during the fixation process, so that the silver pigment M therein are arranged in parallel to the paper P without overlapping each other in the thickness direction of the paper P and thus have a high orientation and a high FI value.

In the initial stage of usage of the silver developer TS, the image formation apparatus 1 prints the print pattern PT2 illustrated in FIG. 10A, which has the silver developer image rectangles ISSa in which many edges of the silver developer image rectangles ISS exist as in Example 1, so as to improve the orientation of the silver pigment M and increase the FI value as illustrated in FIG. 13.

To the contrary, in the middle stage of usage of the silver developer TS in which a proportion of large particle size silver developer TS containing a large amount of silver pigment M is increased, the image formation apparatus 1 prints the print pattern PT3 illustrated in FIG. 10B, which has the silver developer image rectangles ISSb in which the edges of the silver developer image rectangles ISS are fewer than those of the silver developer image rectangles ISSa of the print pattern PT2 as in Example 1, so as to intentionally make the orientation of the silver pigment M worse, to prevent the FI value from becoming too high.

Further, in the late stage of usage of the silver developer TS in which the proportion of the large particle size silver developer TS containing a large amount of the silver pigment M is further increased, the image formation apparatus 1 prints the print pattern PT4 illustrated in FIG. 10C, which has the silver developer image rectangles ISSc in which the edges of the silver developer image rectangles ISS are fewer than those of the silver developer image rectangles ISSb of the print pattern PT3 as in Example 1, so as to intentionally make the orientation of the silver pigment M worse, to prevent the FI value from becoming too high as illustrated in FIG. 14.

Next, the reason why the C* value is stable from the start of use of the silver developer TS in the image formation unit 10S to the end of use of the developer in Example 1 is described below. Here, as illustrated in FIG. 15, assuming that the interval between the silver developers TS is constant, as the particle size of the silver developer TS is larger as illustrated in FIG. 15B, the silver developer TS spreads more during the fixation so as to cover more of the cyan developer TC. As described above, the particle size of the silver developer TS increases as the dot count d of the image formation unit 10S increases. When the particle size of the silver developer TS becomes larger (FIG. 15B) compared to the case where the particle size of the silver developer TS is small (FIG. 15A), the silver developer TS hides more of the cyan developer TC, so as to decrease the exposed area of the cyan developer TC. Accordingly, the C* value decreases as the dot count d increases, as in Comparative Example 1 illustrated in FIG. 12.

To the contrary, as described above, the silver developer TS existing at the edge of the silver developer image IS has a space in which the silver developer TS can spread in the direction along the paper surface of the paper P, and therefore tends to spread during the fixation. For this reason, compared to the print pattern PT2 in which the number of divisions of the silver developer image IS is large and thus the number of the edges of the silver developer image IS is large, in the print pattern PT4 in which the number of divisions of the silver developer image IS is small and thus the number of the edges of the silver developer image IS is small, an area of the silver developer IS that hides the cyan developer image IC due to the spread of the silver developer IS toward the upper surface of the cyan developer image IC during the fixation becomes smaller.

Therefore, as the particle size of the silver developer TS becomes larger due to an increase in the dot count d of the image formation unit 10S, the image formation apparatus 1 reduces the number of divisions of the silver developer image IS as in Example 1, so as to widen the exposed area of the cyan developer TC, to thereby prevent the C* value from decreasing. Accordingly, the C* value can be maintained to be high from the early stage to the late stage of usage of the silver developer TS.

From the above results, by printing in the method of Example 1, the image formation apparatus 1 can change the print pattern PT to be appropriate for the silver developer TS in which the portion of the large particle size silver developer increases as the dot count d of the image formation unit 10S increases, and thus can achieve both a high glitter and a wide color gamut and maintain the glitter and the color gamut to be stable from the start of usage of the silver developer TS until the end of usage of the silver developer TS when the silver developer is used up.

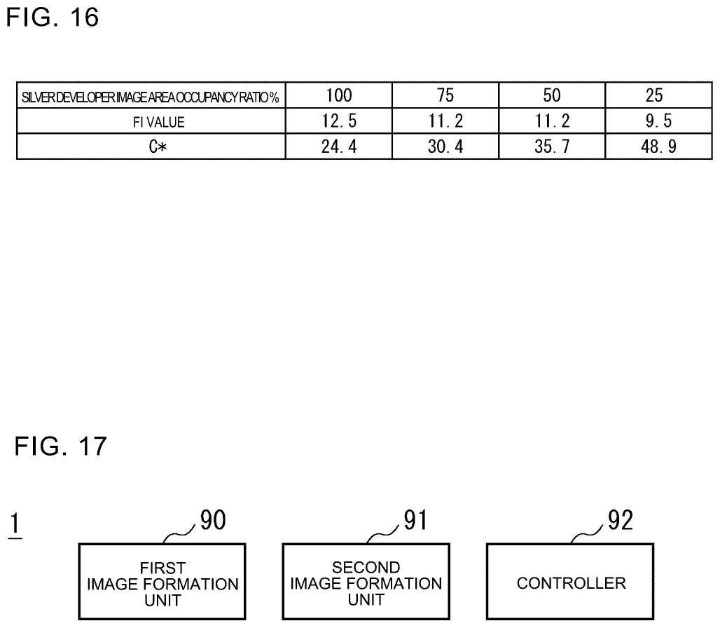

Next, the reason why the silver developer image area occupancy ratio of the print pattern PT is set to 50% is described. FIG. 16 is a diagram illustrating the measurement results of the FI value and the C* value as the silver developer image area occupancy ratio is changed to 100%, 75%, 50% and 25%. The FI value and the C* value are measured by the above-mentioned measuring method, and the dot counts d of the image formation unit 10S are approximately the same values at all the silver developer image area occupancy ratios. Further, the print pattern PT printed when the silver developer image area occupancy ratio is 100% is the print pattern PT1 (FIG. 5), and the print pattern PT printed when the silver developer image area occupancy ratio is 50% is the print pattern PT4 (FIG. 8).

As illustrated in FIG. 16, the lower the silver developer image area occupancy ratio, the higher the C* value becomes, approaching 60, which is the C* value for the cyan monochrome. On the other hand, as illustrated in FIG. 16, the lower the silver developer image area occupancy ratio, the lower the FI value. When the silver developer image area occupancy ratio is 25%, the FI value is less than 10.0, which results in insufficient glitter. For this reason, the image formation apparatus 1 achieves both of a wide color gamut and a high glitter by setting the silver developer image area occupancy ratios of the print patterns PT2, PT3, and PT4 to 50%.

### 7. Functional Configuration of Image Formation Apparatus

Here, when basic functions related to the print processing in the image formation apparatus 1 are illustrated by a functional block diagram, the functional block diagram is as illustrated in FIG. 17.

A first image formation unit 90 (a first image formation part, or a first image formation section) corresponds to the image formation unit 10S (FIG. 1), includes the developer storage space 31 (FIG. 2) as a storage part in which the silver developer serving TS as the glitter developer is stored and is configured to form the silver developer image IS serving as the glitter developer image with the silver developer TS.

A second image formation unit 91 (a second image formation part, or a second image formation section) corresponds to the image formation unit 10C (FIG. 1) and is configured to form a color developer image (for example, a cyan developer image, in an embodiment) serving as a non-glitter developer image.

A controller 92 corresponds to the print controller 3 (FIG. 3), controls the operation of the first image formation unit 90 according to print data which is received. The controller 92 forms, when a glitter image is formed on the sheet P serving as a medium based on predetermined print data with an amount of silver developer stored in the storage part being a first remaining amount, the silver developer image IS in which a ratio of the glitter image formed per unit area is a first area ratio. The controller 92 forms, when the glitter image is formed on the sheet P based on the predetermined print data with the amount of silver developer stored in the storage part being a second remaining amount less than the first remaining amount, the silver developer image IS in which the ratio of the glitter image formed per unit area is a second area ratio greater than the first area ratio. Here, the glitter image is not an image that includes only a region where no silver developer is present on the sheet P but an image that includes a region where at least the glitter developer (silver developer) is present on the sheet P.

### 8. Effects and the Like

Here, when the image formation apparatus 1 performs printing using the silver developer TS which is the glitter developer, a printed product having a high glitter can be obtained but when printing is repeated, the glitter of the silver developer TS tends to be increased. Hence, each time printing is repeated, the glitter of the silver printed product tends to be increased little by little.

This phenomenon is considered to occur because the silver developer TS that includes a large amount of glitter pigment (silver pigment M) and the silver developer TS that includes a small amount of glitter pigment (silver pigment M) are mixed due to variations in manufacturing. Since the silver developer TS contains a flat glitter pigment, as compared with a general color developer, large variations in particle diameter are produced. As the particle diameter of the silver developer TS is lower, the amount of conductive glitter pigment contained is lower, and thus the amount of charge is increased, with the result that the silver developer is easily developed. In other words, in the glitter developer, large variations in particle size distribution are produced (particle size distribution is wide), and thus as the glitter developer that is developed at the start of use of the silver developer TS, that is, in the initial stage of printing, the silver developer TS of a small particle diameter that contains a small amount of glitter pigment and has low conductivity is prioritized. On the other hand, as the dot count d increases, the ratio of the silver developer TS that contains a large amount of glitter pigment and has high conductivity is increased in the image formation unit 10S, with the result that the glitter developer that is developed at the late stage of printing before the completion of use of the silver developer TS is considered to be the silver developer TS of a large particle diameter that contains a large amount of glitter pigment. In other words, the silver developer TS of a small particle diameter tends to be developed in the early stage of use of the silver developer TS, whereas the silver developer TS of a large particle diameter tens to be developed in the late stage of use of the silver developer TS. Hence, when printing is repeated, the ratio of the silver developer TS of a large particle diameter in the image formation unit 10S is increased as the silver developer TS is consumed. The silver developer TS of a large particle diameter includes a large amount of glitter pigment so as to have a high glitter. The reason why the glitter (the FI value) is changed from the initial stage to the later stage of usage of the silver developer is considered to be that the particle size distribution of the glitter developer is wide.

For this reason, compared to non-electrophotographic image formation apparatuses such as inkjet printers, the electrophotographic image formation apparatus 1 can enhance the glitter of the printed product to improve the print quality of the printed product by fixing the glitter developer while applying pressure to the glitter developer, but this makes the print quality susceptible to changes in the particle size of the glitter developer over the course of use of the glitter developer.

To the contrary, assuming that a state where the dot count d of the image formation unit 10S is 0 or more and less than 1661 k is defined as a state where the remaining amount of the silver developer TS in the developer storage space 31 of the image formation unit 10S is the first remaining amount, the image formation apparatus 1 is configured to, when the remaining amount of the silver developer TS is the first remaining amount, the print pattern PT2 in which the number of divisions of the silver developer image IS is eight, as a first division number, as in Example 1. Further, assuming that a state where the dot count d of the image formation unit 10S is 1661 k or more and less than 3344 k is defined as a state where the remaining amount of the silver developer TS in the developer storage space 31 of the image formation unit 10S is the second remaining amount less than the first remaining amount, the image formation apparatus 1 is configured to, when the remaining amount of the silver developer TS is the second remaining amount, print the print patter PT3 in which the number of divisions of the silver developer image IS is four as a second division number smaller than the first division number, as in Example 1.

To the contrary, assuming that a state where the dot count d of the image formation unit 10S is 1161 k or more and less than 3344 k is defined as a state where the remaining amount of the silver developer TS in the developer storage space 31 of the image formation unit 10S is the first remaining amount, the image formation apparatus 1 is configured to, when the remaining amount of the silver developer TS is the first remaining amount, the print pattern PT3 in which the number of divisions of the silver developer image IS is four as a first division number, as in Example 1. Further, assuming that a state where the dot count d of the image formation unit 10S is 3344 k or more and less than 9863 k is defined as a state where the remaining amount of the silver developer TS in the developer storage space 31 of the image formation unit 10S is the second remaining amount less than the first remaining amount, the image formation apparatus 1 is configured to, when the remaining amount of the silver developer TS is the second remaining amount, print the print patter PT4 in which the number of divisions of the silver developer image IS is two as a second division number smaller than the first division number, as in Example 1.

In other words, the image formation apparatus 1 decreases the number of divisions of the silver developer image in the print pattern PT, as the remaining amount of the silver developer TS in the developer storage space 31 of the image formation unit 10S decreases (that is, as the cumulative used amount of the silver developer TS increases).

Hence, the image formation apparatus 1 can suppress an increase in metallic luster even when the remaining amount of silver developer TS decreases. In this way, the image formation apparatus 1 can obtain a printed product having a stable metallic luster (FI value) from the start of use of the silver developer TS in the image formation unit 10S (that is, in the early stage of printing) until the completion of use of the silver developer TS (that is, the end stage of printing) in which the silver developer TS runs out.

Further, for this reason, the image formation apparatus 1 can suppress a decrease in the color gamut (that is, a narrowing of the color gamut) even if the remaining amount of the silver developer TS becomes small. Accordingly, the image formation apparatus 1 can obtain a printed product having a stable color gamut (C*) from the start of use of the silver developer TS in the image formation unit 10S (that is, in the early stage of printing) until the completion of use of the silver developer TS (that is, the late stage of printing) in which the silver developer TS is used up.

In this way, the image formation apparatus 1 can achieve both a high glitter and a wide color gamut, and can maintain a stable glitter and a stable color gamut from the early stage to the late stage of the image formation unit 10.

Further, when the image formation apparatus 1 performs color metallic printing using the method of Comparative Example 1, which is a conventional method, the silver developer 100% is fixed on the color developer (for example, the cyan developer in an embodiment) 100%, and thus the color developer is covered with the silver developer TS, resulting in a narrow color gamut and a darkened impression of the printed product.

In contrast, the image formation apparatus 1 prints the print patterns PT2 (FIG. 6), PT3 (FIG. 7), and PT4 (FIG. 8), each having the silver developer image area occupancy ratio of 50%. Therefore, the image formation apparatus 1 can expose the cyan developer TC by forming the silver developer TS not on the entire surface of the cyan developer TC but only on a part of the entire surface of the cyan developer TC. As a result, the image formation apparatus 1 can increase the C* value and obtain a printed product with a wide color gamut, compared to the case where the silver developer image area occupancy ratio is 100%.

Furthermore, even if the dot count d of the image formation unit 10S increases, the image formation apparatus 1 is configured to print the print patterns PT2, PT3 and PT4 while maintaining the constant silver developer image area occupancy ratio of 50% although the shapes of the silver developer image rectangles ISS thereof are different from each other. Therefore, the image formation apparatus 1 can obtain a printed product that has both high glitter (FI value) and high color tone (luminous reflectance difference ΔY) from the initial stage to the late stage of printing.

In the configuration described above, the image formation apparatus 1 includes: the storage part in which the silver developer TS is stored; the first image formation unit 90 configured to form the silver developer image IS of the silver developer TS; and the controller 92 configured to control the operation of the first image formation unit 90 based on print data received, wherein the controller 92 is configured: when forming the glitter image on the paper P based on a predetermined print data in the state where the remaining amount of the silver developer TS in the storage part is the first remaining amount, to form the silver developer image IS such that the glitter image is divided per unit area by the first division number; when forming the glitter image on the paper P based on the predetermined the print data in the state where the remaining amount of the silver developer TS in the storage part is the second remaining amount less than the first remaining amount, to form the silver developer image IS such that the glitter image is divided per unit area by the second division number smaller than the first division number.

In this way, the image formation apparatus 1 can suppress an increase in metallic luster even when the remaining amount of silver developer TS decreases, and can obtain a printed product having a stable metallic luster (FI value) from the start of use of the silver developer TS in the image formation unit 10S until the completion of use of the silver developer TS in the image formation unit 10S.

### 9. Other Embodiments

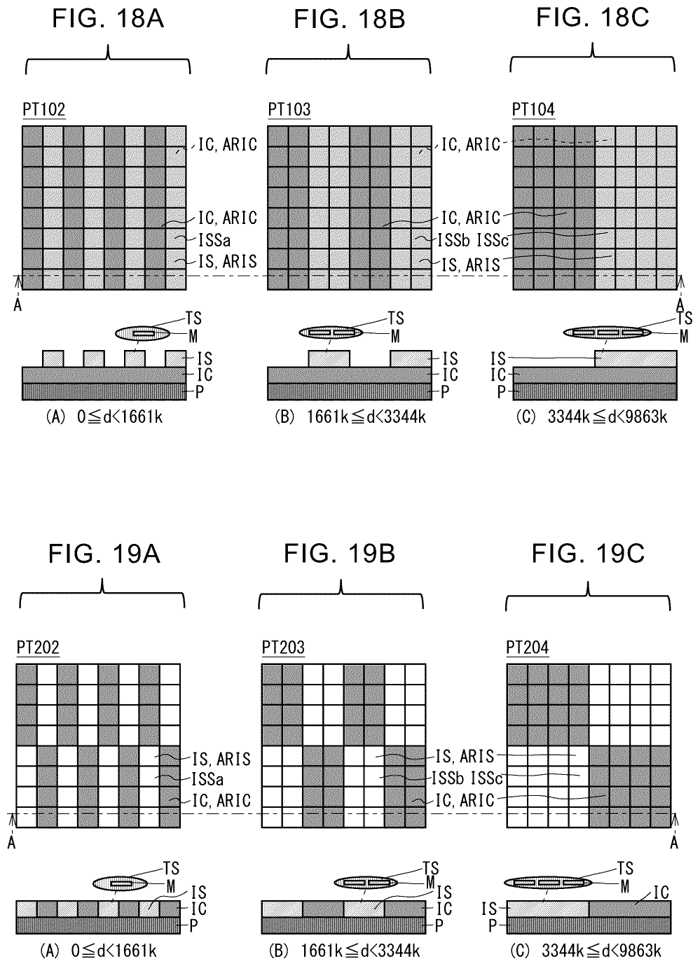

In one or more embodiments described above, the case has been described in which the image formation apparatus 1 prints the print pattern PT2 (FIG. 6), the print pattern PT3 (FIG. 7), the print pattern PT4 (FIG. 8) in which the silver developer image rectangles ISS (the silver developer image rectangles ISSa, ISSb, and ISSc) are arranged in a grid pattern. However, the invention is not limited to this. For example, as illustrated in FIG. 18, in which parts corresponding to those in FIG. 10 are given the same reference numerals, the image formation apparatus 1 may print the print pattern PT102, the print pattern PT103, the print pattern PT104 in which the silver developer image rectangles ISS (the silver developer image rectangles ISSa, ISSb, and ISSc) are arranged continuously linearly in the vertical direction. In the case where the print pattern PT102, the print pattern PT103, and the print pattern PT104 are printed by the image formation apparatus 1, the printed product having a stable metallic luster (FI value) and a stable color gamut (C*) can be obtained from the start to the end of use of the silver developer TS in the image formation unit 10S although pattern shaped vertical lines may be visible in the printed product.

Further, in one or more embodiments described above, the case has been described in which the image formation apparatus 1 prints the print pattern PT2 (FIG. 6), the print pattern PT3 (FIG. 7), and the print pattern PT4 (FIG. 8) in which a the cyan developer image IC is disposed between the paper P and the silver developer image IS so as to overlap with the silver developer image IS, that is, the silver developer image IS and the cyan developer image IC are arranged adjacent to each other in the thickness direction of the paper P. However, the invention is not limited thereto. For example, the image formation apparatus 1 may pint patterns PT202, PT203, and PT204 in which the cyan developer image IC is not provided between the paper P and the silver developer image IS overlapped with each other but the cyan developer image IC and the silver developer image IS are arranged adjacent to each other in the direction along the paper surface of the paper P, as illustrated in FIG. 19, in which parts corresponding to those in FIG. 10 are given the same reference numerals. In the case where the print pattern PT202, the print pattern PT203, and the print pattern PT204 are printed by the image formation apparatus 1, the printed product having a stable metallic luster (FI value) and a stable color gamut (C*) can be obtained from the start to the end of use of the silver developer TS in the image formation unit 10S although the C* value is smaller with respect to the print patterns PT2, PT3, and PT4.

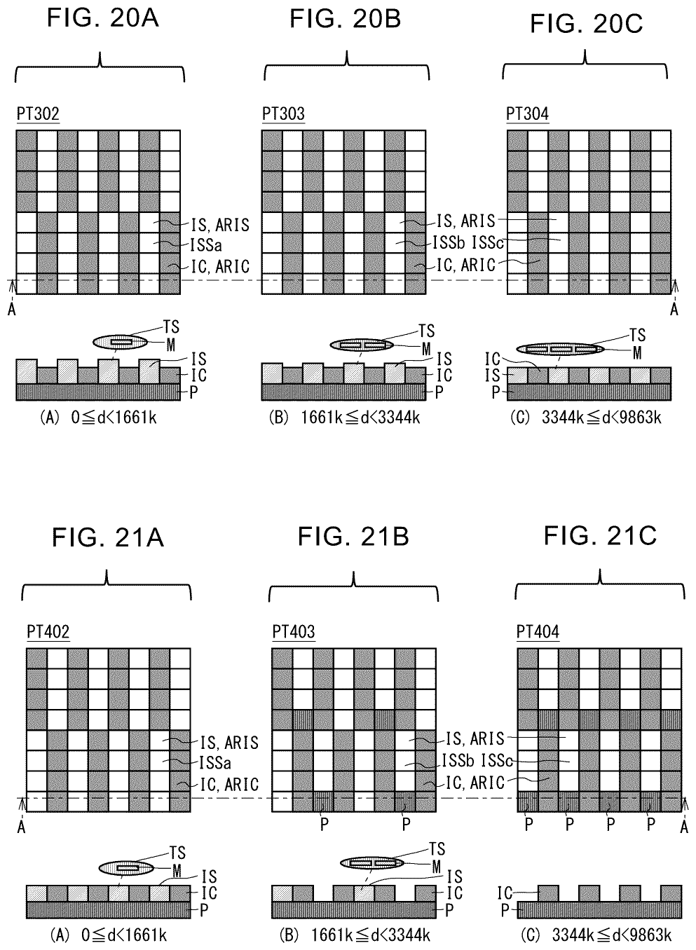

Furthermore, in one or more embodiments described above, the case has been described in which the image formation apparatus 1 prints the print pattern PT in which the number of divisions of the silver developer image IS increases as the dot count d of the image formation unit 10S increases, as in the print pattern PT2 (FIG. 6), the print pattern PT3 (FIG. 7), and the print pattern PT4 (FIG. 8). However, the invention is not limited thereto. For example, as illustrated in FIG. 20 in which parts corresponding to those in FIG. 10 are given the same reference numerals, the image formation apparatus 1 may print a print pattern PT in which the silver developer image IS and the cyan developer image IC are arranged adjacent to each other in the direction of the paper surface of the paper P and in which as the dot count d of the image formation unit 10S increases, the amount of the silver developer image IS formed on the medium sequentially decreases while remaining the number of divisions of the silver developer image IS, as in a print pattern PT302, a print pattern PT303, and a print pattern PT304. In this case, the image formation apparatus 1 may change the amount of the silver developer image IS formed on the medium, by changing the absolute value of the bias voltage applied to each part, changing the printing image density of the developer, changing the transfer efficiency in the secondary transfer part 49, or the like. At the early stage of printing the silver developer TS, the silver developer TS containing less silver pigment M is more likely to be developed more, and at the late stage of printing the silver developer TS, the silver developer TS containing more silver pigment M is more likely to be developed. Therefore, by printing the print pattern PT302, the print pattern PT303, and the print pattern PT304, the image formation apparatus 1 increases the amount of the silver developer image IS formed on the medium in the early stage of printing when the silver developer TS that contains less silver pigment M and has a lower FI value is more likely to be developed, whereas reduces the amount of the silver developer TS formed on the medium in the late stage of printing when the silver developer TS that contains more silver pigment M and has a higher FI value is more likely to be developed. With this, it is possible to maintain the FI value constant from the early stage to the late stage of printing while reducing the amount of the silver developer TS consumed in the late stage of printing. Furthermore, in the print pattern PT302, the print pattern PT303, and the print pattern PT304, the image formation apparatus 1 may arrange the cyan developer image IC between the paper P and the silver developer image IS so as to overlap with the silver developer image IS. Further, the image formation apparatus 1 may print a print pattern in which, as the dot count d of the image formation unit 10S increases, the amount of the silver developer image IS formed on the medium decreases and the number of divisions of the silver developer image IS decreases.

Further, in one or more embodiments described above, the case has been described in which the image formation apparatus 1 prints the print pattern PT2 (FIG. 6), the print pattern PT3 (FIG. 7), and the print pattern PT4 (FIG. 8) in which the silver developer image area occupancy ratio is constant at 50% even if the dot count d of the image formation unit 10S increases. However, the invention is not limited thereto. For example, as illustrated in FIG. 21 in which parts corresponding to those in FIG. 10 are given the same reference numerals, the image formation apparatus 1 may print a print pattern PT in which the silver developer image IS and the cyan developer image IC are arranged adjacent to each other in the direction of the paper surface of the paper P and in which as the dot count d of the image formation unit 10S increases, the silver developer image area occupancy ratio sequentially decreases while remaining the number of divisions of the silver developer image IS, as in a print pattern PT402, a print pattern PT403, and a print pattern PT404. In the case where the print pattern PT402, the print pattern PT403, and the print pattern PT404 are printed by the image formation apparatus 1, the FI value can be kept constant from the initial stage to the late stage of printing although the C* value decreases as the dot count d of the image formation unit 10S increases. Furthermore, in the print pattern PT402, the print pattern PT403, and the print pattern PT404, the image formation apparatus 1 may arrange the cyan developer image IC between the paper P and the silver developer image IS so as to overlap with the silver developer image IS. Further, the image formation apparatus 1 may print a print pattern in which, as the dot count d of the image formation unit 10S increases, the silver developer image area occupancy ratio decreases and the number of divisions of the silver developer image IS decreases.

Further, in one or more embodiments described above, the case has been described in which the image formation apparatus 1 prints the print pattern PT in which the silver developer image IS and the cyan developer image IC are combined. However, the invention is not limited thereto. For example, the image formation apparatus 1 may print the print pattern PT in which only the silver developer image IS is present with omitting the cyan developer image IC, and print, when the remaining amount of silver developer TS decreases, a print pattern in which the number of divisions of the silver developer image is decreased. In this case, that is, even in the case where the cyan developer image IC is not present in the print pattern PT, the image formation apparatus 1 can suppress an increase in metallic luster when the remaining amount of the silver developer decreases and thereby obtain a printed product having a stable metallic luster (FI value) from the start of use of the silver developer in the image formation unit 10S (that is, in the beginning of printing) until the completion of the silver developer (that is, the end of printing), since whether or not the cyan developer image IC is present has little effect on the FI value.

Further, in one or more embodiments described above, the case has been described in which the image formation apparatus 1 successively decreases the number of divisions of the silver developer image in the print pattern PT to 8, 4, 2 as the remaining amount of silver developer TS in the developer storage space 31 of the image formation unit 10S decreases (that is, as the cumulative used amount of the silver developer TS increases) However, the invention is not limited thereto. For example, when the developer container 12 is replaced during the printing so as to add a new silver developer TS to the developer storage space 31, the image formation apparatus 1 may reset the number of divisions of the silver developer image IS to 8, and then decrease sequentially the number of divisions of the silver developer image IS of the print pattern PT to 4, and 2 again, as the remaining amount of the silver developer TS in the developer storage space 31 of the image formation unit 10S decreases.

Further, in one or more embodiments described above, the case has been described in which the image formation apparatus 1 prints the print pattern PT2 (FIG. 6) when the number of divisions of the silver developer image IS is 8, prints the print pattern PT3 (FIG. 7) when the number of divisions of the silver developer image IS is 4, and prints the print pattern PT4 (FIG. 8) when the number of divisions of the silver developer image IS is 2. However, the invention is not limited thereto. For example, the image formation apparatus 1 may print with print patterns including silver developer images IS of various other shapes as long as the number of divisions of the silver developer image IS is satisfied.

Further, in one or more embodiments described above, the case has been described in which the image formation apparatus 1 prints the print pattern PT in which as the dot count d of the image formation unit 10S increases, the number of divisions of the silver developer image IS is decreased to 8, 4, and 2 sequentially as in the print pattern PT2 (FIG. 6), the print pattern PT3 (FIG. 7), and the print pattern PT4 (FIG. 8). However, the invention is not limited thereto. For example, the image formation apparatus 1 may be configured to, as the dot count d of the image formation unit 10S increases, decrease the number of divisions of the silver developer image IS of the print pattern sequentially, for example, to 16, 8, and 4, or various other numbers of divisions as long as the number of divisions of the silver developer image IS of the print pattern decreases sequentially.

Further, in one or more embodiments described above, the case has been described in which the image formation apparatus 1 prints the print pattern PT2 (FIG. 6), the print pattern PT3 (FIG. 7), and the print pattern PT4 (FIG. 8) in which the silver developer image area occupancy ratio is 50%. However, the invention is not limited thereto. For example, the image formation apparatus 1 may print print patterns having various other silver developer image area occupancies as long as a wide color gamut and high glitter can be achieved at the same time.

Further, in one or more embodiments described above, the case has been described in which the image formation apparatus 1 uses the cyan developer TC as a color developer (a non-glitter color developer). However, the invention is not limited thereto. For example, the image formation apparatus 1 may use a yellow developer or a magenta developer as a color developer (a non-glitter color developer). Further, in the image formation apparatus 1, at least two of a yellow developer, a magenta developer, and a cyan developer TC may be mixed as a color developer (a non-glitter color developer). The narrow color gamut is caused by the fact that the silver developer TS is fixed while covering the color developer, so even when the image formation apparatus 1 uses a developer other than the cyan developer TC as a color developer, the same effect as in the case of the cyan developer TC can be obtained.

Furthermore, in one or more embodiments described above, the case has been described in which in the image formation apparatus 1, aluminum (Al) included in the glitter pigment used when the developer is generated is a minute flake having a planar part. The invention is not limited thereto, and the image formation apparatus 1 may use aluminum (Al) included in the glitter pigment that is formed with small pieces of any shapes such as a spherical shape, a rod shape, or the like. In addition, the glitter pigment is not limited to the glitter pigment including aluminum (Al), and various other pigments having glittering properties may be used, such as pearl pigments (natural mica) and inorganic pigments including titanium oxide.

Further, in an embodiment described, the case has been described in which the metal contained in the glitter pigment used for producing the developer is aluminum (Al). The invention is not limited thereto, and the image formation apparatus 1 may use various metals, such as brass, iron oxide, or the like, as the metal contained in the glitter pigment used for producing the developer. In this case, a color expressed by the developer that is fixed on the paper P will correspond to the color of the metal.

In one or more embodiments described above, the case has been described in which the image formation apparatus 1 uses the silver developer TS as an example of the glitter developer, and metallic color expressivity is evaluated. The invention is not limited to this case, and in the image formation apparatus 1 may use a gold developer as an example of the glitter developer. In such a case, the gold developer is preferably produced by the following manufacturing method. In one or more embodiments described above, aluminum is added as the glitter pigment when manufacturing the silver developer TS. To the contrary, when manufacturing a gold developer, in addition to adding aluminum, adding a yellow pigment (for example, as an organic pigment, C. I. Pigment Yellow 180), a magenta pigment (for example, as an organic pigment, C. I. Pigment Red 122), a red-orange fluorescent dye (FM-34N_Orange made by SINLOIHI Company, Limited) and a yellow fluorescent dye (FM-35N_Yellow made by SINLOIHI Company, Limited) to manufacture the gold developer. Since the gold developer includes the glitter pigment added therein as described above, as in the silver developer TS, each time printing is repeated, the glitter increases little by little. Hence, the image formation apparatus 1 can obtain the same effects by performing the control same as the control described above with the gold developer and the color developer being combined.

Furthermore, in one or more embodiments described above, the case has been described in which in the image formation apparatus 1, the CPU 23 serving as a detector or a detection section is used to detect, based on the dot count d of the image formation unit 10S, the remaining amount of silver developer TS in the image formation unit 10S. The invention is not limited thereto, and in the image formation apparatus 1, the CPU 23 serving as a detector or a detection section may be used to detect, based on the result of detection performed by a developer remaining amount detection bar provided in the developer storage space 31, the remaining amount of silver developer TS in the image formation unit 10S.

Furthermore, in one or more embodiments described above, the case has been described in which the invention is applied to the image formation apparatus 1 that forms the image with the developer used in the one-component development method. However, the invention is not limited thereto, and the invention may be applied to an image formation apparatus that forms an image with a developer used in a two-component development method in which a carrier and a toner is mixed and an appropriate amount of charge is provided to the toner by utilization of friction between the carrier and the toner. Specifically, in the case of the two-component development method, the glitter developer including an external additive in addition to the glitter toner and the carrier are stored in the developer container 12 and the developer storage space 31. Even in the two-component development method, when large variations in the particle size distribution of the glitter developer are produced (particle size distribution is wide), in the initial stage of printing, the glitter developer of a small particle diameter having low conductivity is preferentially consumed, and thus when printing is repeated, the ratio of the glitter developer of a large particle diameter in the developer storage space 31 is increased. For example, as compared with a ratio of the glitter developer of a large particle diameter to all the glitter developer in the developer storage space 31 when the glitter developer is supplied zero times from the developer container 12 to the developer storage space 31, a ratio of the glitter developer of a large particle diameter to all the glitter developer in the developer storage space 31 when the glitter developer is supplied 10 times is great. This is because since the glitter developer of a small particle diameter is preferentially consumed, as the number of times the glitter developer is supplied is increased, the remaining amount of glitter developer of a large particle diameter in the developer storage space 31 is increased. Hence, regardless of the remaining amount of carrier in the developer storage space 31, in the glitter developer of the two-component development method, as the remaining amount of glitter developer in the developer storage space 31 is decreased, the invention is applied, with the result that the same effects can be obtained.

Furthermore, in one or more embodiments described above, the case has been described in which the invention is applied to the image formation apparatus 1 of a so-called intermediate transfer method (or a secondary transfer method) in which the developer images of individual colors are sequentially transferred from the photosensitive drums 36 of the image formation units 10 to the intermediate transfer belt 44 so as to overlap each other and the developer images are transferred from the intermediate transfer belt 44 to the sheet P. The invention is not limited to this case, and the invention may be applied to an image formation apparatus of a so-called direct transfer method in which developer images of individual colors are sequentially transferred from the photosensitive drums 36 of the image formation units 10 to the sheet P serving as a medium so as to overlap each other. In the case of the image formation apparatus 1 of the intermediate transfer method in an embodiment, the image formation apparatus 1 includes the primary transfer rollers 45 serving as the transfer part for transferring the developer images on the photosensitive drums 36 to the intermediate transfer belt 44 serving as a medium and the secondary transfer roller 46 serving as the transfer part for transferring the developer images on the intermediate transfer belt 44 to the sheet P serving as a medium. On the other hand, in the case of the image formation apparatus of the direct transfer method, the image formation apparatus includes only transfer rollers serving as a transfer part for transferring developers on photosensitive drums to a sheet serving as a medium.

Furthermore, in one or more embodiments described above, the invention is applied to the image formation apparatus 1 including five image formation units 10. The invention is not limited to this. The invention may be applied to an image formation apparatus including four or less image formation units 10 or six or more image formation units 10 as appropriate.

Furthermore, in one or more embodiments described above, the case has been described in which the invention is applied to the image formation apparatus 1 that includes the image formation unit 10 in which the developer container 12 is detachable from the image formation main body 11. However, the invention is not limited thereto. For example, the invention may be applied to an image formation apparatus that includes an image formation unit in which the developer container 12 is integral with the image formation main body 11.

Furthermore, in one or more embodiments described above, the case has been described in which when the print data of the color of silver 100% and cyan 100% is received from the external apparatus 20, the image formation apparatus 1 selects, based on the special color silver dedicated data conversion table 88, according to the dot count d of the image formation unit 10S, any one of the print pattern PT2 (FIG. 6), the print pattern PT3 (FIG. 7), and the print pattern PT4 (FIG. 8) and performs printing. However, the invention is not limited thereto. For example, when the external apparatus 20 acquires print data of a color of silver 100% and cyan 100% with a printer driver from an application, the external apparatus 20 may acquire data of the dot count d of the image formation unit 10S or data of the remaining amount of the silver developer TS in the developer storage space 31 from the image formation apparatus 1, reference a predetermined special color silver dedicated data conversion table based on the acquired data, select any one of the print pattern PT2 (FIG. 6), the print pattern PT3 (FIG. 7), and the print pattern PT4 (FIG. 8) and transmit the selected print pattern to the image formation apparatus 1. In such a case, the image formation apparatus 1 prints the print pattern PT received from the external apparatus 20 without processing the print pattern PT.

Furthermore, in one or more embodiments described above, the case has been described where the invention is applied to the image formation apparatus 1, which is a single function printer. For example, the invention may be applied to an image formation apparatus having multiple functions such as a multi-function peripheral having a photocopier function and a facsimile device function.

Further, in one or more embodiments described above, the case has been described in which the invention is applied to the image formation apparatus 1. However, the invention is not limited thereto. For example, the invention may be applied to various electronic devices such as photocopiers and the like, which form images on paper P or other media using developers by an electrophotographic method.

Furthermore, the invention is not limited to one or more embodiments and modifications described above. That is, the application range of the invention covers embodiments obtained by arbitrarily combining some of or all of one or more embodiments and modifications described above. The scope of the invention also extends to an embodiment in which a part of the configuration in any one of one or more embodiments and modifications described above that is extracted is replaced or diverted with a part of the configuration of any one of one or more embodiments and modifications, or an embodiment in which the extracted part is added to any of one or more embodiments and modifications described above.

Furthermore, in one or more embodiments described above, the case has been described in which the image formation apparatus 1 serving as an image formation apparatus comprises the first image formation unit 90 serving as a first image formation unit and the controller 92 serving as a controller. However, the invention is not limited thereto, and an image formation apparatus may include a controller and a first image formation unit that have various other configurations.

The disclosure can be used for forming an image on a medium using a developer containing a metallic pigment by an electrophotographic method.

1. An image formation apparatus comprising:
a first image formation unit that includes a storage part that accommodates therein a glitter developer and is configured to form a glitter developer image with the glitter developer; and
a controller configured to control an operation of the first image formation unit based on print data received, wherein
the controller is configured to: when forming a glitter image on a medium based on a predetermined print data in a state where a remaining amount of the glitter developer in the storage part is a first remaining amount, to form the glitter developer image such that the glitter developer image is divided per unit area by a first division number; and when forming the glitter image on the medium based on the predetermined print data in a state where the remaining amount of the glitter developer in the storage part is a second remaining amount less than the first remaining amount, to form the glitter developer image such that the glitter developer image is divided per unit area by a second division number smaller than the first division number.

2. The image formation apparatus according to claim 1, wherein
the controller is configured to: when forming the glitter image on the medium based on the predetermined print data in the state where the remaining amount of the glitter developer in the storage part is the first remaining amount, to form the glitter developer image such that the glitter developer image with a predetermined area ratio per unit area; and when forming the glitter image on the medium based on the predetermined print data in the state where the remaining amount of the glitter developer in the storage part is the second remaining amount, to form the glitter developer image such that the glitter developer image with the predetermined area ratio per unit area.

3. The image formation apparatus according to claim 1, wherein
the controller is configured to: when forming the glitter image on the medium based on the predetermined print data in the state where the remaining amount of the glitter developer in the storage part is the second remaining amount, to form the glitter developer image that is divided by the first division number such that the glitter developer image with a first area ratio per unit area, when forming the glitter image on the medium based on the predetermined print data in the state where the remaining amount of the glitter developer in the storage part is the second remaining amount, to form the glitter developer image such that the glitter developer image with a second area ratio smaller than the first area ratio per unit area.

4. The image formation apparatus according to claim 1, further comprising:
a second image formation unit that includes one or more image formation units each of which is configured to form a non-glitter developer image with a non-glitter developer, wherein the controller is configured to, when forming the glitter developer image on the medium based on the predetermined print data, control the first image formation unit and the second image formation unit to form the non-glitter developer image adjacent to the glitter developer image.

5. The image formation apparatus according to claim 4, wherein
the controller is configured to form the non-glitter developer image between the glitter developer image and the medium.

6. The image formation apparatus according to claim 4, wherein
the controller is configured to form the non-glitter developer image outside an area where the glitter developer image is formed on the medium.

7. The image formation apparatus according to claim 4, wherein
the second image formation unit includes an image formation unit that is configured to form a developer image of at least one of a black developer, a yellow developer, a magenta developer, and a cyan developer.

8. The image formation apparatus according to claim 1, wherein
the controller is configured to: when forming the glitter image on the medium based on the predetermined print data in the state where the remaining amount of the glitter developer in the storage part is the first remaining amount, to form the glitter developer image an amount of which is a first formation amount; and when forming the glitter image on the medium based on the predetermined print data in the state where the remaining amount of the glitter developer in the storage part is the second remaining amount, to form the glitter developer image an amount of which is a second first formation amount smaller than the first formation amount.

9. The image formation apparatus according to claim 1, further comprising
a detector configured to detect the remaining amount of the glitter developer contained in the storage part, wherein the controller is configured to control the operation of the first image formation unit based on the remaining amount including the first remaining amount and the second remaining amount detected by the detector.

10. An image formation apparatus comprising:
a first image formation unit that includes a storage part that accommodates therein a glitter developer and is configured to form a glitter developer image with the glitter developer; and a controller configured to control an operation of the first image formation unit based on print data received, wherein the controller is configured to: when forming a glitter image on a medium based on a predetermined print data in a state where a remaining amount of the glitter developer in the storage part is a first remaining amount, to form the glitter developer image that is divided by a first division number such that the glitter developer image is formed with a first area ratio per unit area; and when forming the glitter image on the medium based on the predetermined print data in a state where the remaining amount of the glitter developer in the storage part is a second remaining amount less than the first remaining amount, to form the glitter developer image that is divided by the first division number such that the glitter developer image is formed with a second area ratio smaller than the first area ratio per unit area.

11. The image formation apparatus according to claim 1, wherein
the storage part further accommodates therein a carrier.

12. The image formation apparatus according to claim 1, wherein
a volume average particle diameter of the glitter developer is in a range of 15.01±3.00 μm.

13. The image formation apparatus according to claim 1, wherein
the glitter developer includes a gritter pigment, wherein a volume average particle diameter of the glitter pigment is 5.3 μm or more and 5.7 μm or less.
